(19) United States
(12) Patent Application Publication
(10) Pub. No.: US 2012/0233020 A1
(43) Pub. Date: Sep. 13, 2012

(54) USING SOCIAL NETWORK AND TRANSACTION INFORMATION

(75) Inventors: George Eberstadt, New York, NY (US); Karen McGrane, New York, NY (US)

(73) Assignee: TurnTo Networks, Inc., New York, NY (US)

(21) Appl. No.: 13/393,008

(22) PCT Filed: Dec. 2, 2010
(86) PCT No.: PCT/US10/58740

§ 371 Date: Feb. 28, 2012

Related U.S. Application Data
(63) Continuation-in-part of application No. 12/629,520, filed on Dec. 2, 2009.
Application No. 12/629,520 is a continuation-in-part of application No. PCT/US08/87943, filed on Dec. 22, 2008.
Application No. PCT/US08/87943 is a continuation-in-part of application No. 12/098,618, filed on Apr. 7, 2008.
Application No. 12/098,618 is a continuation-in-part of application No. 12/026,972, filed on Feb. 6, 2008, now abandoned.
Application No. 12/026,972 is a continuation-in-part of application No. 11/968,431, filed on Jan. 2, 2008.

(51) Int. Cl. G06Q 30/00; G06Q 30/06

(52) U.S. Cl. 705/26.41; 705/26.1

(57) ABSTRACT

Among other things, a user, who is engaged in a commercial activity on a commercial online site, is exposed to computer-stored information that (a) is associated with another user of the online site, (b) would otherwise be private to the other user, (c) relates to the commercial activity of the user, and (d) is controlled by the site.

### BACKGROUND

This application is a continuation-in-part of U.S. patent application Ser. No. 12/629,520, filed Dec. 2, 2009, and is related to U.S. patent application Ser. No. 12/098,618, filed Apr. 7, 2008, which is a continuation-in-part of U.S. patent application Ser. No. 12/026,972, filed Feb. 6, 2008, which is a continuation-in-part of U.S. patent application Ser. No. 11/968,431, filed Jan. 2, 2008, and to PCT application PCT/US 2008/087943, all incorporated here by reference in their entirety (the incorporated patent applications).

This description relates to using social network (SN) and transaction information.

As explained in the incorporated patent applications, SN information includes, for example, information about connections between people, and demographic and other information about the people who are the subject of the connections. Information about real life connections among people may be stored in a database (also called a who-knows-whom database, a SN graph, or a SN database) in which each person (and the demographic and other information—for example an email address and an assigned unique identifier—about the person) can be represented in a node and the connections among people can be represented by connections that join nodes.

SN databases are created and maintained by SN sites, for example, Facebook or Linkedln. The node information and the connection information of the database can be derived directly from the users of a SN site through a user interface of the site (for example, when the user first registers or adds information later) or may be inferred from actions of users on the site, or may be obtained from other sources. For example, a separate site that sells shoes may provide to the host of a SN site a list of products purchased by people who are users of the SN site. The SN site may then, for example, display this information in association with other information about a “target” user, when an interested user of the SN site is viewing information about the target user. For example, if Bill is viewing Carol's profile on Facebook, he could be presented with a list of products that Carol has recently bought.

Although a site may have a primary function other than maintaining a SN, such as retail sales, the site also may generate and maintain a proprietary SN database about its customers. The proprietary SN database may include node information and connection information that is derived explicitly or implicitly from the customers as they register as users of the site, maintain their user profiles on the site, and use the site for its main purpose. Such a site may use the proprietary SN database to enhance the experience of its users and improve the sales or other performance of the site.

Users who want to participate in the proprietary SN databases of multiple sites may register separately for each of them by providing demographic and personal information (including an email address) and defining connections they have with other people who are users of the site. To complete the creation of the connections for each of the proprietary SN databases, the other people whom they have identified are asked to verify and consent to the inclusion of the connection information in the database.

A SN site may make its SN database available to other parties who may develop applications to use the SN information. These applications are installed by the users on both sides of a connection defined by the SN database in order for the SN aspects of the applications to be usable.

### SUMMARY

In general, in an aspect, a user, who is engaged in a commercial activity on a commercial online site, is exposed to computer-stored information that (a) is associated with another user of the online site, (b) would otherwise be private to the other user, (c) relates to the commercial activity of the user, and (d) is controlled by the site.

Implementations may include one or more of the following features. The user who is engaged in the commercial activity and the other user are known to have a connection with one another. The commercial activity includes shopping for a product or service. The information includes information about activities of the other user on the online site. The information includes information about a product or service bought by the other user on the site. The information comprises information about purchases at the site by users of the site. An interaction is facilitated between the user who is engaged in the commercial activity and the other user. The facilitating includes initially displaying some of the information without any information that is private information of the other user. The facilitating comprises serving as a conduit for a question of the user directed to the other user, and for an answer of the other user. The facilitating is assisted by a third party social networking system. The information includes a recommendation of the other user. The user and the other user are connected through a social networking site. The connection of the user and the other user is determined by information provided by the user, the other user, or both. A connection between the user and the other user is identified based on identifiers associated with at least one of the users, and selecting information to be exposed, based on the identified connection. The other user has given permission to the exposing of the information to the user who is engaged in the commercial activity. The information that is exposed to the user is a selected subset of available information that could be exposed to the user. The information that is exposed is organized by a product item or a product category.

In general in an aspect, an online inquiry is received from a user who is contemplating a transaction on an online site. One or more other users of the online site are identified to whom to direct the inquiry, based on stored information about other transactions that have occurred on the online site.

Implementations may include one or more of the following features. Data is obtained (from the stored transaction information) that enables the online inquiry to be sent to the other users. The stored information about other transactions is controlled by the online site. The online inquiry relates to a product that the user is contemplating buying, and at least some of the other transactions include transactions that relate to the product that the user is contemplating buying. The user and the one or more other users are friends in a social networking system. A response to the inquiry is obtained from one or more of the other users, and the responses are exposed to the user who is contemplating the transaction.

In general, in an aspect, a question about a product is sent to a potential responder who can be inferred to have knowledge about the product, based on data that is controlled by an online site and is about an action of the potential responder at the online site.

Implementations may include one or more of the following features. The action of the potential responder includes purchasing the product. The online site includes a retail online site. The question is sent by email. The question is displayed to the responder at an online site. The potential responder is selected from a pool of potential responders. The selection is based on at least one factor that indicates that the responder will provide a useful response to the question.

In general, in an aspect, data is received, from an online site, about an action of a potential responder at the online site from which it can be inferred that the potential responder has knowledge about a product. An answer of the potential responder to a question about the product is returned, for use by the online site.

Implementations may include one or more of the following features. The action of the potential responder includes purchasing the product. The online site includes a retail online site. The data received from the online site identifies that the potential responder bought the product on the site. The data received from the online site is part of a body of data about transactions that occurred at the online site. The answer is used by the online site to increase traffic on the site. The answer is used by the online site to increase purchases on the site. The answer is provided by the online site to a shopper who posed the question together with an invitation to purchase the product. The answer is posted with the question on a page on a social networking site that is associated with the online site from which the data was received. The answer is provided in an email.

In general, in an aspect, a question about a product, from a shopper at an online site, is sent to one or more potential responders who can be inferred to have knowledge about the product, based on data that is controlled by one or more other online sites and is about actions of the potential responders at the other online sites.

Implementations may include one or more of the following features. The actions of the potential responders include purchasing the product. The online sites include retail online sites. The question is sent by email. The question is sent by displaying it to the potential responders at online sites. The potential responders are selected from a pool of potential responders. The selection is based on at least one factor that indicates that the responders will provide useful responses to the question. The data received from the online site identifies that the potential responder bought the product on the site. The data received from the online sites is part of a body of data about purchase transactions that occurred at the online sites. The question is used by the online site to increase traffic on the site. The question is used by the online site to increase purchases on the site.

In general, in an aspect, data about actions of one or more potential responders is received from one or more online sites. It can be inferred from the data that the potential responders have knowledge about one or more products. Answers, of potential responders to questions about the products, are returned to other online sites.

Implementations may include one or more of the following features. The actions of the potential responders include purchasing the product. The online sites include retail online sites. The questions are sent by email. The questions are sent by displaying them to the potential responders at online sites. The potential responders are selected from a pool of potential responders. The selection is based on at least one factor that indicates that the responders will provide useful responses to the question. The data received from the online site identifies that the potential responders bought the product on the sites. The data received from the online sites is part of a body of data about purchase transactions that occurred at the online sites. The questions are used by the online sites to increase traffic on the sites. The questions are used by the online sites to increase purchases on the sites. The answers are provided by the online sites to shoppers who posed the question together with invitations to purchase the product. The answers are posted with the questions on pages on social networking sites that are associated with the online sites from which the data was received. The answers are provided in emails.

In general, in an aspect, an online site is incentivized to deliver as much data as possible about actions of people on the site from which knowledge by the people about respective products can be inferred. The site is incentivized by using the data to perform steps that will enhance the likelihood that a shopper who is interested in products the site offers who have asked questions about those products will buy the products.

Implementations may include one or more of the following features. The questions that have been asked by the shoppers about the products have been asked at a location other than the online site that delivers the data. The data includes transactions that include purchases of products on the online site. The data is used to identify potential responders to the questions. The data is used to select potential responders to the question from a pool of potential responders. The data is used to determine potential responders who have agreed to permit the communications to be made to them on behalf of the online site. The likelihood that shoppers will buy is enhanced by returning for use by the online site, answers to the questions provided by responders identified using the data.

In general, in an aspect, questions about products are sent to potential responders who have engaged in activities on an online site from which it can be inferred that they have knowledge about the products. The potential responders' consent to having the questions sent to them is inferred from permissions that the potential responders have granted to the online site to send messages to them.

Implementations may include one or more of the following features. The permissions have been provided as part of registration by the responders with the online site prior to a time when the questions are to be sent. The permissions granted to the online site are general permissions to communicate with the responders. The method of claim in which a responder can opt out of receiving future questions at the time when a question has been sent to him.

In general, in an aspect, a service is provided to accept, from any arbitrary sources, identifications of items of commerce and questions about the items, and to respond to the questions with (a) answers from responders who can be inferred to have knowledge about the items based on activities of the responders at other sites and (b) pointers to the sites where the activities of the responders occurred.

Implementations may include one or more of the following features. The service includes an application programming interface that may be used by any arbitrary entity to establish a feature in which the entity can send the questions and receive the answers automatically. The service is provided by an independent third party syndicator of the questions and answers.

In general, in an aspect, an answer is displayed to a shopper to a question posed by the shopper about a product. The answer is provided by a responder who can be inferred to have knowledge about the product. Also displayed with the answer is a control that enables the shopper to proceed with a purchase of the product.

Implementations may include one or more of the following features. The answer is displayed on an online site used by the shopper. The answer is provided in an email to the shopper. The answer is displayed on a page of a social networking site. The control includes a “buy” button that initiates for the shopper a process for buying the product. The control includes an image of the product. The question is posed by the shopper on the online site or on a page of a social networking site.

In general, in an aspect, questions posed by shoppers about products on a business's website are included on the business's page on a social networking site. Answers to the questions are provided by responders who can be inferred to have knowledge about the respective products.

Implementations may include one or more of the following features. The questions and answers are included as posts. The page of the social networking site includes a place for displaying information about products available at the business's website and a place for shoppers to pose questions about the products. The method of claim also including a control to be used by shoppers to initiate a purchase of a product associated with the questions and answers.

In general, in an aspect, a facility is included on a business's page on a social networking site. The facility enables a user to post a question about a product offered by the business and that posts answers from responders who can be inferred to have knowledge about the respective products.

These and other aspects and features, and combinations of them, can be expressed as methods, apparatus, systems, components, program products, methods of doing business, means for performing functions or steps, and in other ways.

Other aspects and features will become apparent from the following description and the claims.

### DESCRIPTION

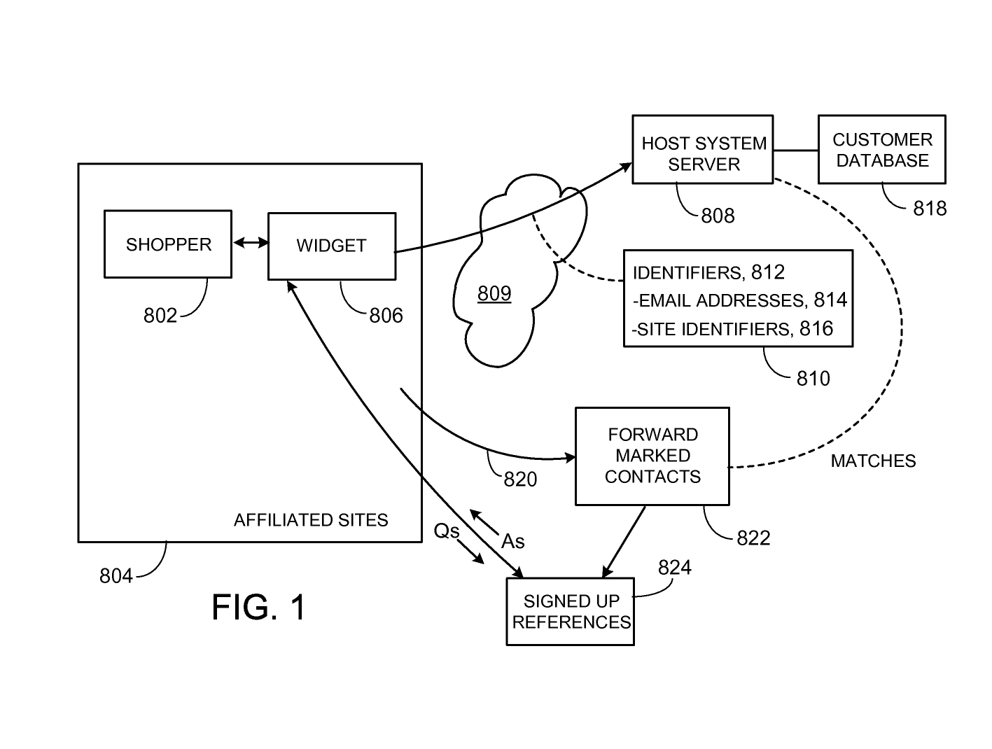

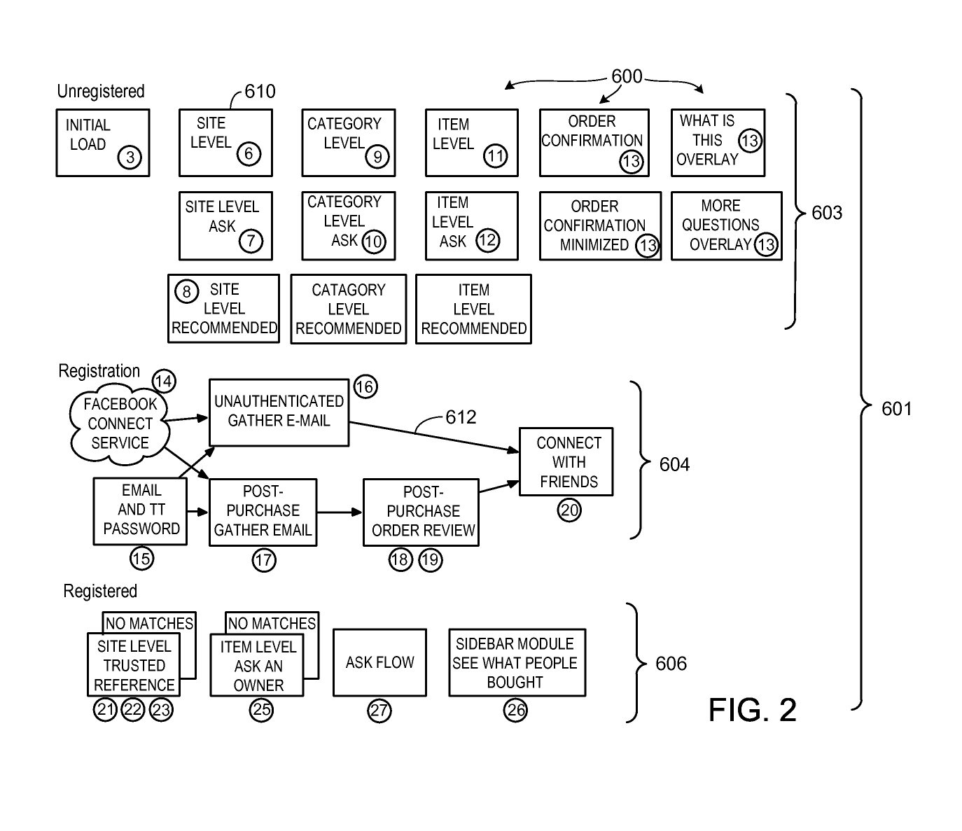

FIGS. 1 and 2 are block diagrams.

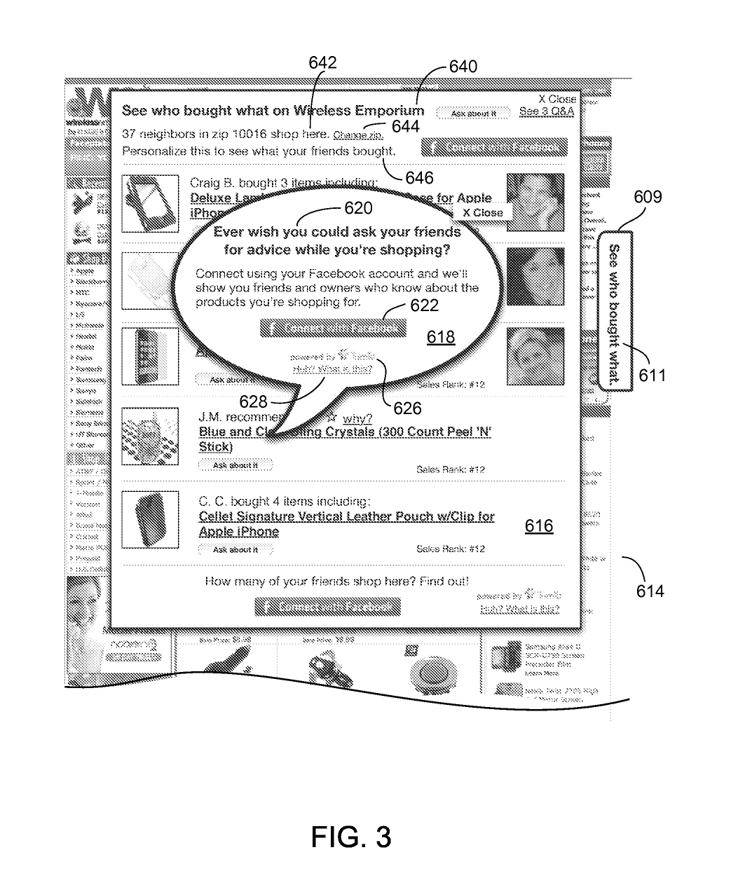

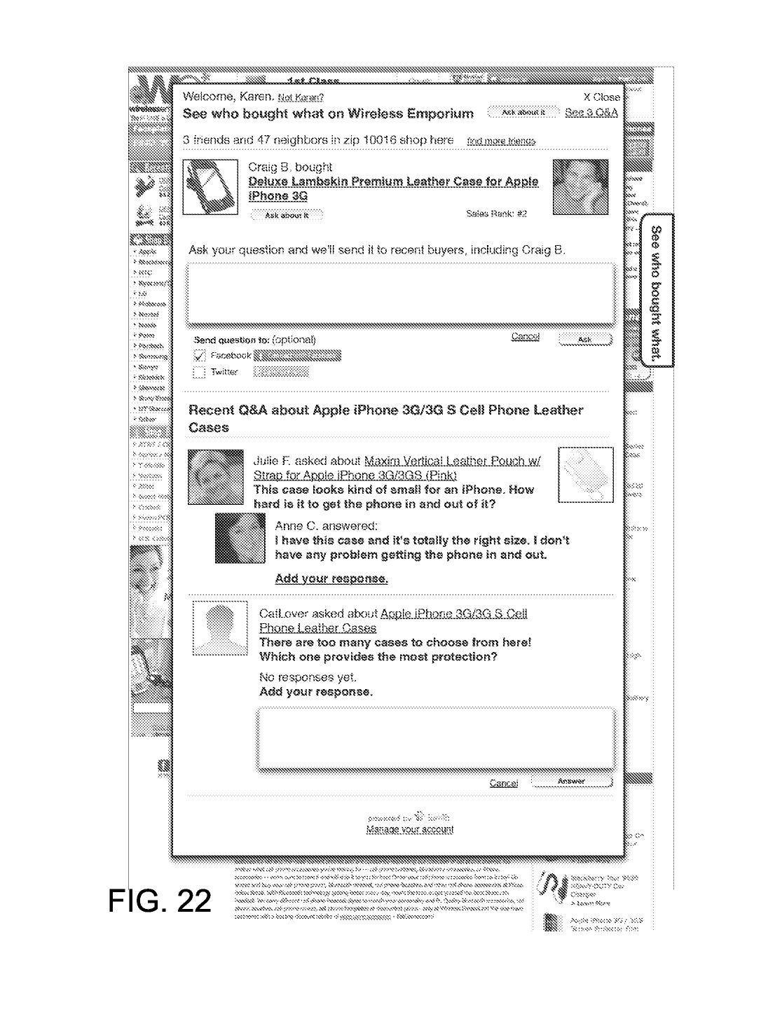

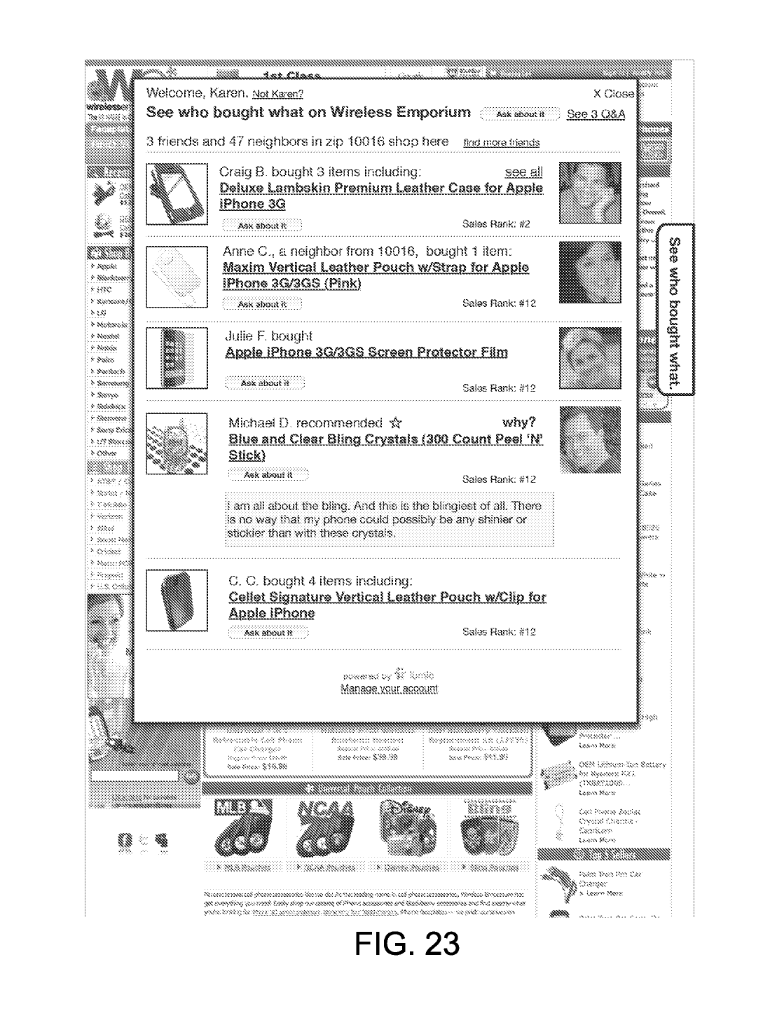

FIGS. 3 through 50 show user interface elements.

As explained and illustrated in the incorporated patent applications, a shared SN system may, among other things, receive, create, aggregate, supplement, organize, maintain, use, make accessible, and distribute SN information in a shared SN repository. The shared information includes, among other things, node information and connection information about users. Users of the shared SN system and users of a wide variety (and potentially a very large number) of other sites (e.g., sites that have subscribed to services provided by or have otherwise become affiliates of the shared system) are able to submit, maintain, update, release, and provide permissions, authorizations, and other controls at a single shared SN repository.

Users of the shared SN system and of sites may then use proprietary or open features and applications that are running at each of the sites or combinations of them and that are designed to rely on and take advantage of the SN information of the users (and information about the users and others stored in the shared SN repository and at other sites that have subscribed to or made other arrangements to use and/or contribute to all or part of the shared SN repository). The features and applications of the sites may be ones that the users already use (for example, retail sites, portals, SN sites, and others), or ones that the users begin to use after having become users of the shared SN system.

We use the term sites extremely broadly to include any on-line or non-online capability, service, facility, resource, feature, or application that can make use of the SN information stored in the shared repository in any way. Many examples of such sites operate using content of a wide variety of kinds Sites include websites of all different types, including portals, commercial sites, individual sites, internal sites of enterprises, and all of the types of content that they support, including applications, audio, video, images, catalogs, and accounts to name a few. Sites may be relatively static or relatively dynamic, such as publications, blogs, review sites, photo, video, and audio sites, user-generated content sites, location information, mapping sites, and other kinds of content sites, among others. Static sites can be of the kind typically used for business to business marketing collateral and non-retail transactional sites (e.g., B2B transactions and client relationships that may not be naturally characterized as a “transaction”). Chat facilities, groups, instant messaging, emailing, and other forms of content based communication fit within the concept of sites.

In general, sites enable users to engage in activities, which we use in its broadest sense. Activities may include, for example, money-based transactions such as retail, wholesale, and business sales activities, investments, and financial instruments, and also non-money-based activities such as bartering, exchanging of information, registration, submission of content, borrowing, lending, and any other kind of exchange or passing of content or value from one party to another or among multiple parties, to name a few. Activities need not involve a bargain or exchange but could also involve, for example, an activity of a user with respect to content that may be available at the site. This could include submitting, updating, modifying, or removing content; searching, sorting, downloading, displaying, presenting, or retrieving content; participating in a group activity as an observer, a player, a critic, or a recipient; registering, signing in, accepting, withdrawing, or terminating rights, participation, membership, or accounts. These are only examples and the term activity is used in an extremely broad sense.

Sites may be present at any location, for example, on servers, on personal work stations, on portable devices, and at other places. Access to sites may occur through any communication channel, such as wired or wireless channels using any kind of communication infrastructure such as the Internet, intranets, dial up communication, dedicated and private networks and the like.

The repository can be part of a server hosted by a party that serves as a clearinghouse, broker, or medium for shared SN and other information derived from many sources and made available to many sites. The server may host a wide variety of other applications that enable it to perform the services and functions described here, and many others. Access to the shared repository and the applications in the server can be made through any communication channel of any kind, including, in some implementations, networks such as the Internet.

The shared SN repository can be created and maintained “once” without duplication of effort and then used by many sites (and users of the shared system and of other sites) in many ways and at many times. Because the users need only register (and provide other SN information) in one place to have their SN information available (with permission) at a large number of sites, they are freed from the need to register and maintain their node information and connection information redundantly at many different sites. This feature significantly increases the chances that users will participate in the shared system. Because users are more likely to participate, the system substantially increases the opportunities for independent sites to create applications that take advantage of the information contained in the shared repository with a reasonable expectation of participation by a large number of users.

As the size, extent, complexity, and completeness of the shared SN system grows, its value to other sites and to users grows.

Other sites that wish to use SN information are able to access, and make a wide variety of uses of the shared SN repository or portions of it, available at a single, convenient location reducing or eliminating the need for the site operator to convince its users to build their social networks within the site. The sites can be completely flexible in how they use the shared SN repository information to best suit their business model and functions and the expectations of their users. Sites can combine all or part of the shared SN repository information with their own user information (for example, SN information about their users, and non-SN information related to their users) for use by their applications. An application development toolkit can be provided to the facilities to simplify their development and integration of such applications.

A variety of business models can be used to finance the shared system 100 and to generate revenue from it. In some models, in order to build the shared SN repository to a significant size quickly, the database and tool kit may be provided to affiliated sites at no charge or a small charge for an initial period of time to encourage those sites to adopt applications that will make use of the shared SN system. Later, a monthly or annual license fee may be charged to the affiliated sites for continued access. A wide variety of revenue models can be used to define the license fees, including licenses based on volume of use, number of transactions, revenue associated with the use, time-based charges, and others. Sometimes we refer to sites that are making use of information in the shared SN repository as affiliates or affiliated sites of the shared SN repository. Affiliates can include sites, other online devices, applications, features, and other entities and enterprises. Typically an affiliate has access to information in the shared SN repository by virtue of an agreement, license, course of dealing, or other authorization.

Other sources of revenue in some business models can include, for example, license fees from advertisers for uses of the shared SN repository, and development by the operator of the shared SN repository of applications that leverage the repository to generate advertising or usage revenues.

It also may be possible to derive other revenue streams from the users of the system 100, for example, by providing premium services associated with the use of the shared SN system or by enabling access by paying users to facilities that are otherwise restricted.

Important features of the shared system include (but are not limited to) the following:

1. The system serves as a builder, clearinghouse, intermediary, and broker for information in the shared SN repository. Other sites (and other parties, including advertisers, manufacturers, distributors, and financial institutions, for example) can make use of the information in the shared repository as the basis of valuable and useful applications and features. Users of the shared system agree in advance to permit information about them that is in the shared repository (and, in some cases, would otherwise be considered confidential) to be communicated from the system to the other sites. The other sites, which are typically controlled independently from the shared system) control the sharing of that information, consistent with permissions given by the users to whom the information belongs, with people with whom the users are connected (according to the connection information in the shared repository). We sometimes refer to people with whom a user is connected simply as the user's connections. The display of the information about the users of the shared SN repository, to users of the other sites is done through the other sites. Each site can store some or all of the information from the shared repository in its own repository, combine it in any way it considers useful with its own information about its own users and other users, and decide how, when, where, in what manner, and under what conditions to display the information to its users. Arrangements are made between applications running on the shared system and applications running on the other sites to assure compliance with the permissions, and to facilitate a potentially large number and wide range of other features between the shared system and the affiliate sites.

2. Information associated with people with whom a user has connections, according, for example, to the shared SN repository, can be displayed by (or the user can be given access in other ways to the information by or from) a site in connection with a transaction or any other activity in which the user of that site is engaging. Thus, the display of the information about the user's connection is not triggered merely when the user specifically indicates an interest in the information about the connection, or users having similar characteristics, or based on selected types of connections (for example, “show me all of the people with whom I have connections and who graduated from the same college as I”). Rather the display (or other giving of access) can be determined on the basis of, in the context of, and at the time when the user is working on a transaction or other activity. For example, if the user has added red wool pants to his shopping cart on the Lands End site, then in conjunction with that proposed purchase, and without further action by the user, information about his connections that may relate to the purchase (for example, his friends who have also bought pants from Lands End) are displayed to the initiating user.

We use the term display to refer broadly to any way in which the information can be exposed or presented to the user (or by which the user may be given any kind of access), for example, by display on a computer monitor, but also on any other device, or by presentation of sounds, video, images, text, applications, or any other content or manner of providing it. Display can also refer to making the information accessible to a user for pickup at another location, for searching, or for downloading in any manner, to name a few examples. Any manner in which the user is aware of the progress or nature of a transaction or activity (in the broadest sense) may be a form of “display”.

3. A user of the system can control the character and level of his relationship with his connections in a complex and finely grained way for later control of how the information about him is used and displayed to others. The user is not limited merely to indicating that he and the other person are “connected” or “not connected”. For example, a user may specify that he knows another user and the other user is therefore a connection, yet the first user can control the extent to which (for example, the time, place, context, frequency, conditions, purpose, and other parameters for which) his information in the shared repository may be displayed (or otherwise made accessible) to the other user. For example, the user could set a permission requirement for his confidential information that would require “ask me” permission on a particular site or other facility before his information could be provided to any of his connections.

Based on this flexible permission arrangement, a user may be able to see, in connection with his use of a facility, things he has in common with people to whom he has a connection, such as when he has purchased (or is considering purchasing) the same item, has traveled to the same place, knows the same people, or is located near the other person. The applications running on the site could include, for example, ones that enable a person to play games and have contests with people with whom he has things in common, enable users to share information about themselves with their connections while restricting access by others; allow communications between two users to be shared exclusively with their connections (for example, “shouts” and ^{“}walls” and “endorsements”. . . ); and be used to permit third parties (e.g., sites, businesses) that have user information that would otherwise be considered private to share that information with a user's connections.

In some implementations, a system widget is provided that includes application code that provides functionality to the affiliate sites using information and services provided by the system server and, in some cases, by the affiliate site or application or other sites or applications. The modules of the system widget include a system application that exposes the functionality of the shared system to the user of the affiliate site or application or feature. The shared system can provide affiliates with application templates, which they may use in the form provided or may modify if required, to create applications. A matching engine compares user IDs provided by the system server to user IDs provided by the affiliate application or site that is making use of the system application and returns matches to the system application, according to rules specified by the system application.

The system widget may provide connection facilities to simplify the retrieval of information from the affiliate applications or sites from which information is to be obtained to support the functions of the system application. The affiliate site or application is a site or application at which users may access the functionality of the system application (some functionality can be accessed by users directly through the system website).

The system widget may provide connection facilities to simplify the retrieval of information from the affiliate applications or sites from which information is to be obtained to support the functions of the system application. The affiliate site or application can be a site or application at which users may access the functionality of the system application (some functionality can be accessed by users directly through the system.com site).

The system widget may use information obtained from applications or sites of the affiliate or from other sources.

To take advantage of SN features on typical sites, each user must identify his SN connections by separate steps on each site. When the user signs up on another site, the user's SN connections must be re-identified to the new site. The repeated identification of SN connections can create a tangle of connections that sometimes may be incomplete or time consuming to re-identify.

Thus, considered at a higher level of abstraction, the shared SN system serves as an aggregation system for users' SN information, enabling them to maintain this information in a single place and to use features and applications that take advantage of the information at a large number of affiliate sites that subscribe to the shared SN system, including affiliate sites that the users already use.

An important feature of the shared system is the shared SN repository. This independent electronic database of SN relationships of a user can include the profiles of the system members, their connections to other system members, and their privacy (and permission) preferences with respect to their connections and to the affiliate sites. The database design can be structured to provide affiliate sites with the information they need to effectively tailor the social experiences they provide to the needs and expectations of their users while recognizing that different sites will need different types of information and also meeting the needs of system users for simplicity and speed.

Here we describe, as examples of broad concepts, how to determine which people (called, for convenience, “references,” without limiting the breadth of the term “people”) will have their identities and transactions on an affiliate's site available to be shown to someone who, for example, is (a) a current user of the site (sometimes called, for convenience, a “shopper” without limiting the breadth of the phrase “current user of the site,”), and (b) also a member of a SN site, for example, the shared SN system.

We sometimes below refer to a shared SN system as a host system—an example of such a shared SN system or host system is TurnTo™, which is accessible at www.turnto.com on the World Wide Web).

One way to identify such references, described earlier, can be called “reverse matching” and works as follows.

When the current user (the shopper) registers to become a member of the host system (often prior to the current shopping session), the user provides information about her contacts, for example, by uploading lists of identifiers (e.g., email addresses or unique identifiers used by social networking sites, such as Facebook) for those contacts. In the course of registration, the registering user agrees to allow those contacts to see purchases of the registered user made at affiliated sites of the host system, for example, when those contacts are shopping (we use the activity of “shopping” here only as a non-limiting example) at those sites.

One of the registered user's contacts who is using (e.g., is a shopper at) one of the affiliated sites may identify himself to the widget of the host system (which is running on the affiliated site) using an identifier such as his email address or his identifier on a social networking site, for example. The host system can then reverse match the entered identifier against identifiers that have been stored for all of the people contained in the database of the host system to find the shopper's contacts, people who could be possible references. The resulting list of references who are contacts of the shopper can then be used to fetch transaction information, from the affiliated site's data, about transactions of the references, for display to the shopper.

With reverse matching, the matches may be limited to contacts who were previously entered by users of the host system. Yet the proportion of all shoppers of an affiliated site who are registered users of the host system and therefore can be reverse matched as references for other shoppers on that site may be relatively small. The experience for shoppers on such a site could be substantially enhanced if transaction information for a higher proportion of the customers of that affiliated site could be used.

To do that, the host system widget can be set up also to identify all contacts of the shopper who have also shopped at the site, using what we call “forward matching.” In this way, the transaction information that can be shown to a shopper is not limited to references who had previously identified the shopper as a contact.

As shown in FIG. 1, in some implementations, a shopper 802 on an affiliated site 804 may interact with the host system widget 806, to upload to the host system server 808 though a network 809, information about his friends and other contacts 810, including various identifiers 812, such as email addresses 814 and social networking site identifiers 816. The server checks (matches) those identifiers against identifiers (e.g., email addresses) of people that are stored in the entire customer database 818 of the affiliated site, whether or not those people have previously registered with the host system. This forward matching can yield a much higher proportion of matching references than would reverse matching. Additional matching can be done to find contacts of contacts of the shopper provided that the intermediate contact is a member of the system.

Without permission granted by each of the references, however, the transaction information of those other shoppers at that site should not yet be shown to the current shopper (for privacy reasons). The forward-matched references have not yet registered as participants in the host system or agreed to let friends and other contacts see their purchases. To entice the shopper to ask to see more, the host system widget displays to the shopper the existence of matching references (but in a way that does not compromise private information at this stage) and their purchases.

The host system widget facilitates the registration by those references and/or enables the shopper to ask the affiliated site (or the system server on behalf of the affiliated site) to send messages (e.g., emails 820) on the shopper's behalf to the forward-matched contacts 822 requesting that they reveal themselves to the shopper, i.e., agree to be references. Each email contains a link that takes the forward-matched contact to a page on the affiliated site where the contact can sign up to be a trusted reference. If the forward-matched contact signs up, the server generates an email to the requesting shopper alerting him that the sign-up contact is now available as a reference. In some implementations, once a forward-matched contact becomes a reference, only people on his contact list can see his identity and his purchases.

In some implementations, it may be possible to eliminate reverse matching altogether as a way to identify available references and to rely solely on such forward matching.

In whatever way the references are identified and consent to participation, it is possible to supplement the features provided by the host system widget to enable the shopper to ask questions of the references and for the references to give answers. In some examples, we call this feature “ask an owner”, because once the reference has been identified as an owner of the same or similar products as the one being considered by the shopper, or at least as someone who has shopped at that store before, the shopper can pose a question that can be answered by the reference.

More broadly, a wide range of possible interactions between the shopper and references can be facilitated either by the site or by the widget, not limited to asking and answering specific product questions. The interactions could include discussions, texting, instant messaging, and other forms of communications, postings of images or videos for viewing, passing of hyperlinks and attachments to messages, for example. The information that is the subject of such communications need not be limited to transaction information.

Once references have been identified and given permissions, however, not all transaction information for each of the references nor all identified references need to be the subject of information displayed back to a shopper. In fact, displaying all of the information could be distracting. Instead, a selection of information can be provided. Furthermore, a wide variety of choices can be made of which kinds of information is shared or displayed, the volume and timing of the displays, and other features.

In some implementations, a goal is to show the shopper a handful of recent customers of the site, and their purchases. This helps the shopper by humanizing the shopping experience and by providing useful information. It also helps the affiliated site by improving the shopping experience and encouraging the shopper to consider buying other products.

Choosing which references and which transactions to show can be done algorithmically at the server, for example, by assigning points to attributes of the transactions in the references, scoring a transaction and the references based on the points, and then displaying information tied to the highest ranking references and/or transactions. A very wide variety of attributes and ranking systems could be used.

For example, points could be awarded to a transaction based on attributes that include how recent the transaction is, how large, whether it relates to items that the affiliated site wants to promote, or whether the transaction is of a customer who has signed up to be a reference, lives near the shopper, or is a repeat buyer, for example. All of these attributes can be assigned points without the server having any registration or contact information from the shopper.

But if the shopper provides a contact or friend list, then the server can factor that into the algorithm. More points could be awarded if the reference customer is a first-degree friend of the shopper, fewer points if the shopper and the references are friends-of-friends, and fewer if they are related only by being in the same groups or networks.

When information about other customers or references and their transactions is displayed the shopper, if the people shown are not signed-up as references, their identities can be shown anonymously, and if they are signed-up references, they can be shown with a name (and photo, if available).

Unlike reverse matching, in forward matching, the contact list of the reference is no longer relevant to matching, only the contact or friend list of the shopper. Becoming a signed-up reference in a forward-matching system can mean, in essence, doing something (or taking any of a wide variety of actions) to confirm that “I am willing to have anyone who claims to be my friend or contact (e.g., as evidenced by having my email or being connected to me on a social networking site), see who I am and information about my transaction.” Other approaches are also possible. The scope of the permissions could be limited or defined in other ways with respect to the information that could be displayed and when, how, and to whom it could be displayed, for example. Different permissions could be of different scopes, selected by the person giving the permission, or imposed by the system or by the affiliate sites.

For the question and answer feature mentioned earlier, the shopper's question need not be directed to a named or specific reference. The server can determine which reference or references to whom to send the question by email. The determination can be made algorithmically taking into account similar attributes to those mentioned earlier. In addition, consideration can be given to how many questions each reference received in the past, whether she answered them, and how quickly. In some implementations, a target reference who is not registered as a participant in the host system, and who agrees to answer questions, can be required to register (sign up) as part of the process of answering. Questions can be delivered by other means than email, like IM or text messages to mobile devices. If such communication channels provide presence awareness, then presence can be considered as a factor in the choice of recipient for a question.

In a broader sense, a host system could be operated in a way to derive information about people's social connections not only from information that they provide directly, but also from information that can be derived from third-party sources. And information about a commonality of website activities engaged in by different people could be accumulated, or may already be available at a wide variety of sites, not limited to merchant sites commercial retail sites. By obtaining and cross-referencing the two bodies of information it may be possible to trigger exchanges of information and interaction among connected people in the context of their engaging in similar kinds of activities.

A very wide variety of implementations of forward matching and question-and-answer features are possible, including the specific examples described below.

For example, FIG. 2 shows three groupings 601 of various states 600 of a system widget 806 that runs on an affiliated site. The three groupings relate to contexts involving respectively activities of an unregistered user 602, a registration process 604, and activities of a registered user 606. Each of the boxes 610 corresponds to at least one other figure that illustrates a screen shot seen by the user when the widget is in that state. In some cases, arrows 612 are used to indicate flow between states. Each of the boxes 610 on FIG. 2 is annotated (using circled numbers) to identify other figures that are associated with the state represented by the box.

As shown in FIG. 3, when a user who is not registered with the host system enters a website 614 of an affiliate, the system widget undergoes an initial load. The initial load results in presentation of a small overlay 609 along an edge of the page on the affiliate's webpage, which contains a link 611 that bears a caption “see who bought what.” The overlay 609 and its caption 611 remain visible throughout the user's session at the website. At any time, if the user invokes the link 611, a overlay box 616 appears that contains a list of related transactions of friends or contacts of the unregistered user and/or other owners of products that the user is interested in.

A callout 618, overlaid on the box 616, contains a message 620 that alerts the unregistered user to a feature of the host system. The feature offers the possibility of getting information about the user's friends or other people who, for example, own products that relate to products that are of interest to the un-registered user (the shopper). The information that could be made available to the shopper could include the identities of those friends or other people, answers to questions, and other kinds of advice, among other things.

The callout 618 also has a link 622 that invites the unregistered user to connect to a social networking site (in this case, Facebook) which will enable the shopper, in effect, to sign up for the feature described above, namely to have shown to him information associated with friends or other contacts of the shopper who, for example, own or know something about the products and/or associated with owners of the products, whether or not those owners are friends of the user. The link 622 is essentially an invitation to the shopper to sign up to be able to get information and ask questions of others and also to be willing to answer questions for others, for example, with respect to products.

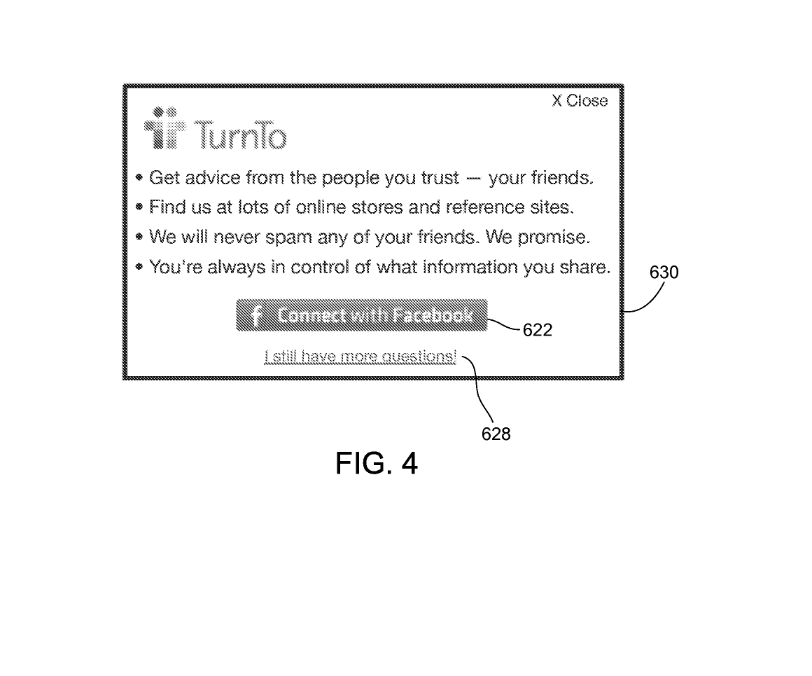

The callout 618 also contains a notation 626 that the service is made available by the host of the system that provides the widget (in this case, TurnTo), and a link 628 that takes the user to an informational overlay 630, shown in FIG. 4. The overlay 630 provides introductory information about the host of the system, repeats the link 622, and offers another link 628 that enables the user to get more information.

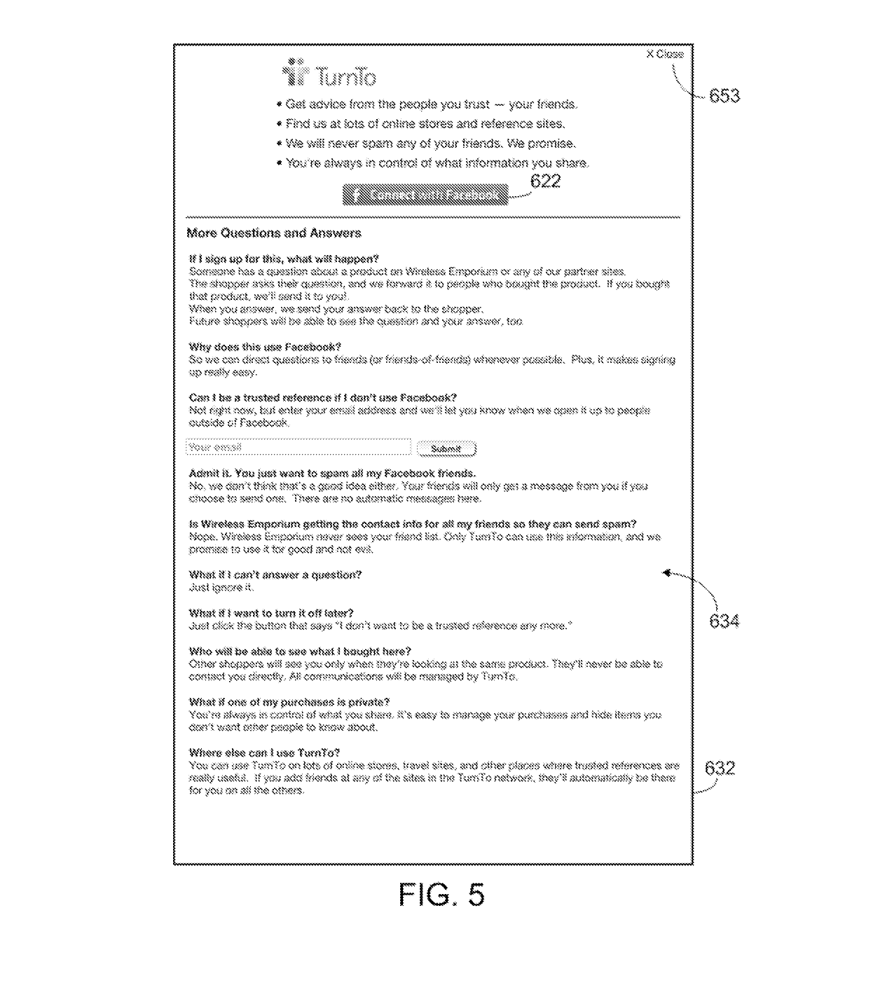

When the user invokes link 628, an additional overlay 632 is displayed as shown in FIG. 5. The overlay 632 repeats the link 622 as well as a series of questions and answers 634.

Each of the overlays shown in the various figures discussed here includes a “close” button 633 in the upper right corner which causes the overlay to disappear when invoked.

Referring again to FIG. 3, the overlay box 616 also contains an alert 640 to the user about the possibility of seeing who bought what on the website. An entry 642 notes for the user the number of people in a ZIP code related to the user's location, how many people shop at the website. A link 644 allows the user to change the ZIP code. An entry 646 points out to the user that, instead of merely seeing purchase information for other people some of whom may not be connected to the user, the user can cause the system to display products bought by the user's friends. Copies of the link 622 are presented in multiple places on the overlays.

Individual entries 648 on overlay box 616 report recommendations and purchases of other users and/or owners. A picture 650 of each product is shown at the left of each entry. And, for some entries, pictures of the owners or other users are shown on the right. Buttons 652 bearing the caption “ask about it” enable the user, who has registered, to ask for advice about the product.

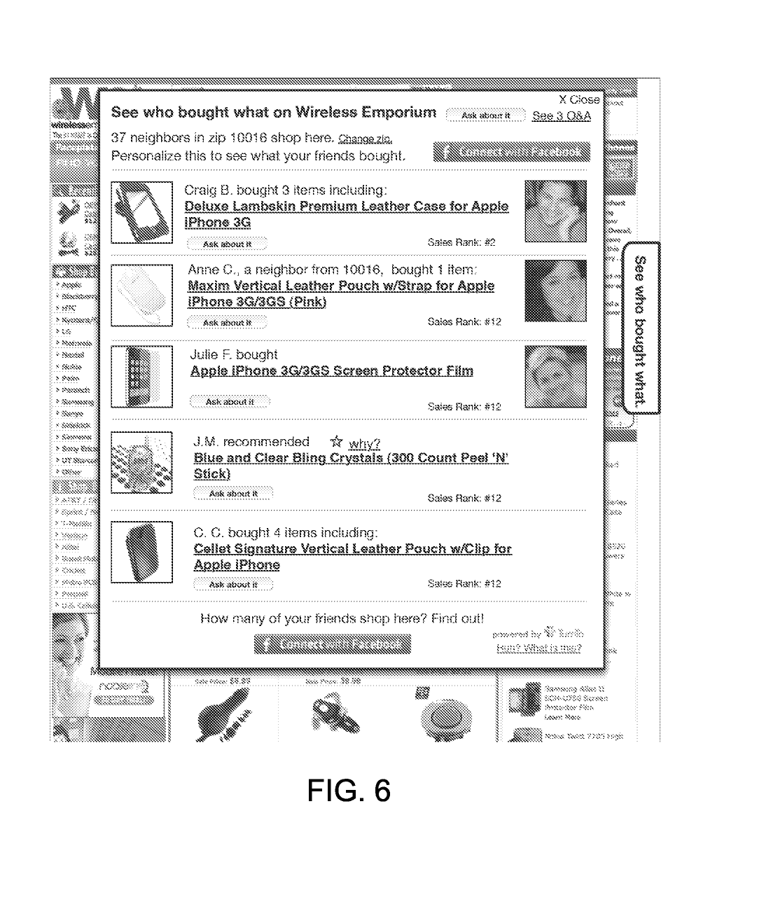

FIG. 6 is like FIG. 5, but with the callout 618 closed.

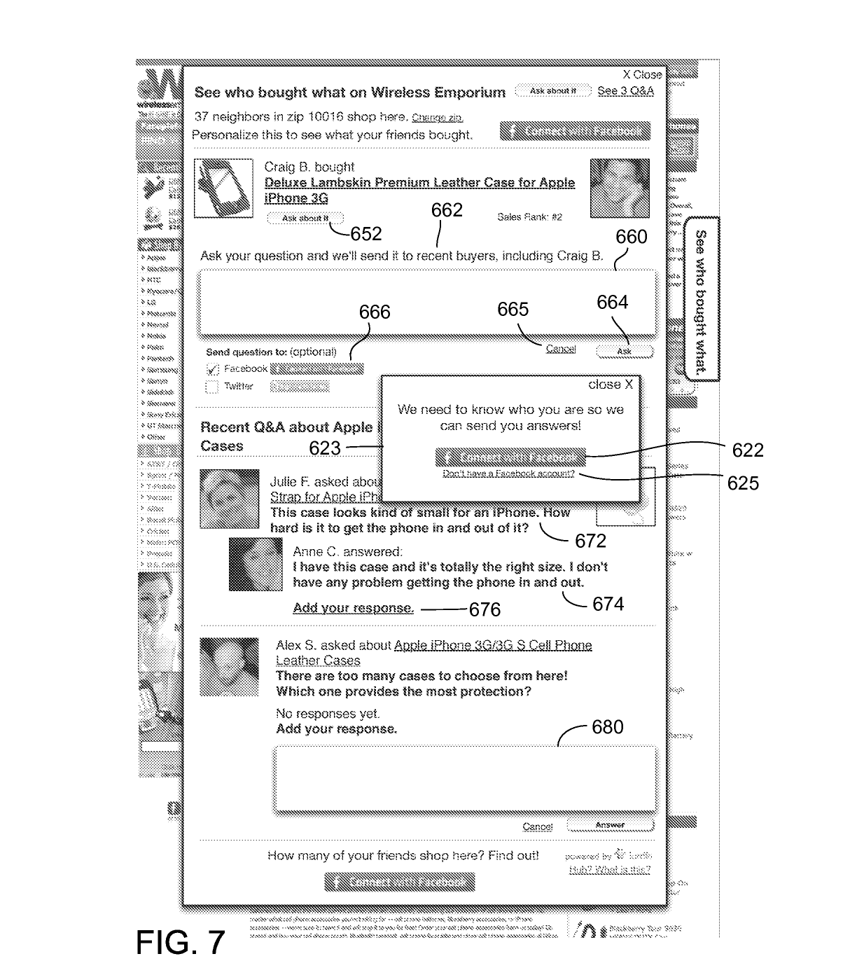

FIG. 7 illustrates that, when user invokes the “ask about it” button 652 in the first entry on figure E, a text entry box 660 opens and an instruction 662 is displayed. The user can then enter a question about the product, for example. If the user is satisfied with the typed question, she can click the “ask” button 664, and if not, the “cancel” link 665. An option 666 is provided to enable the user to have the question posed, not only to users of the current website who own the product, but also to friends of the user on one or more social networking sites. When the user invokes the Ask button 664, because the user in this example is not signed-up, i.e., un-registered, the overlay 668 opens, which asks the user to sign up at the Facebook site, by clicking on the button 622.

FIG. 7 also illustrates, in another entry 670, that Julie F. asked 672 about a product and that Anne C. answered the question 674 even though Julie F and Anne C are not then known to be contacts of the shopper. The shopper is given the opportunity to add a response 676. In a third entry 678, a question posed by Alex S. is displayed. The unregistered user has clicked on the add your response button to cause the text entry box 680 to open and await the user's text answer.

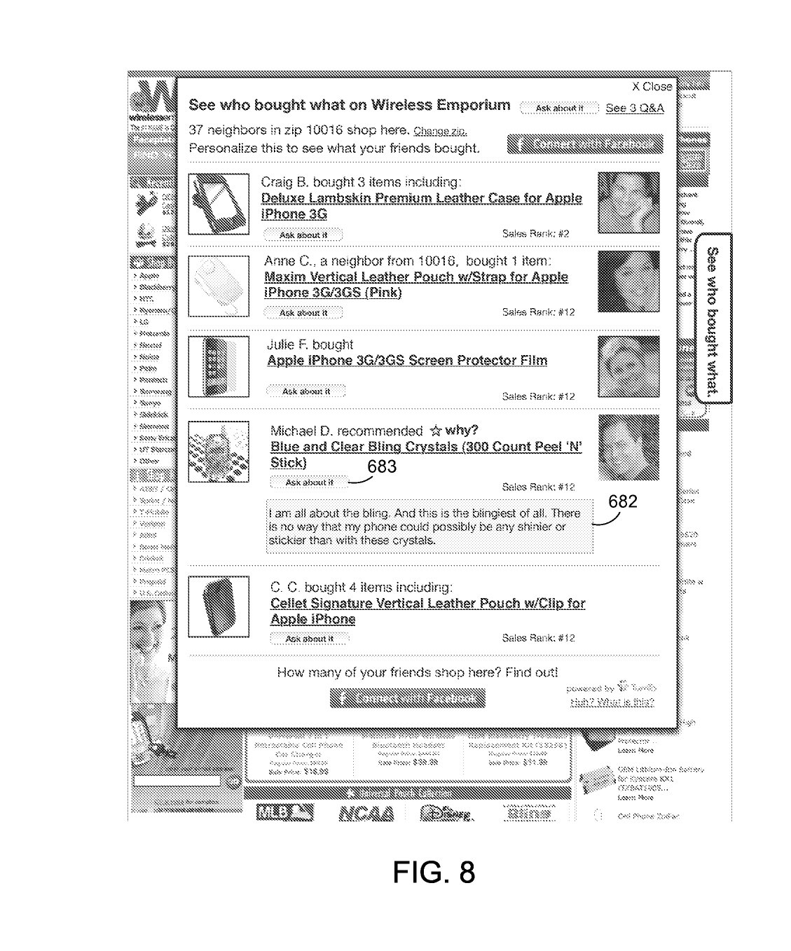

FIG. 8 illustrates the reason 682 given by Michael D for his recommendation of a product. The reason appears when the current user invokes the “ask about it” button 683 in that entry.

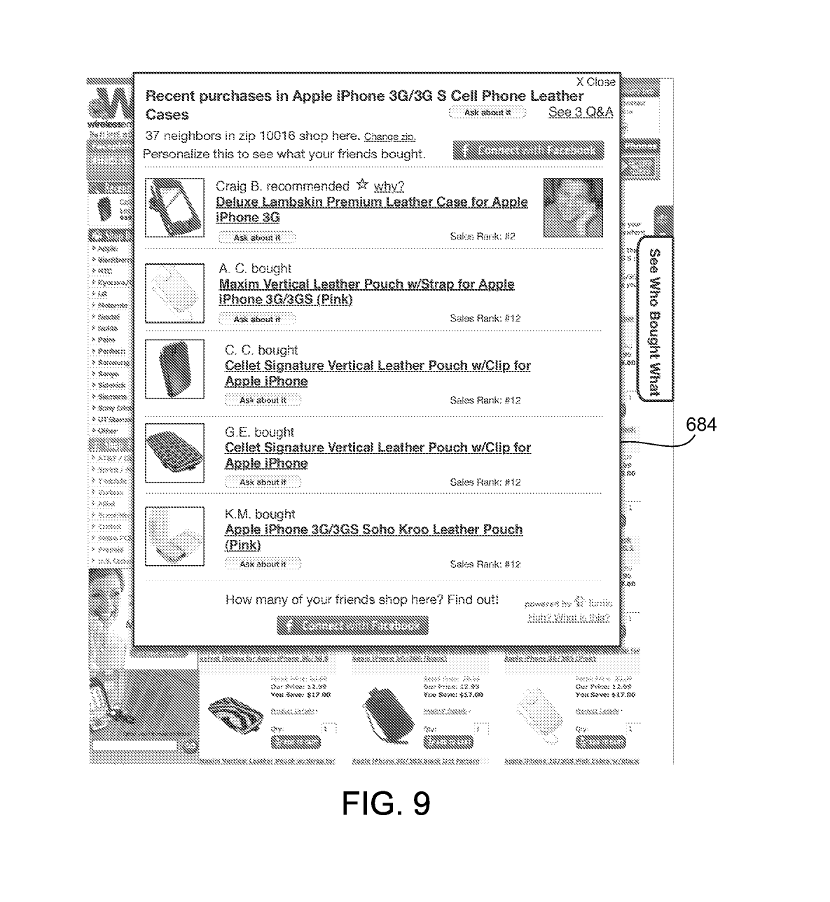

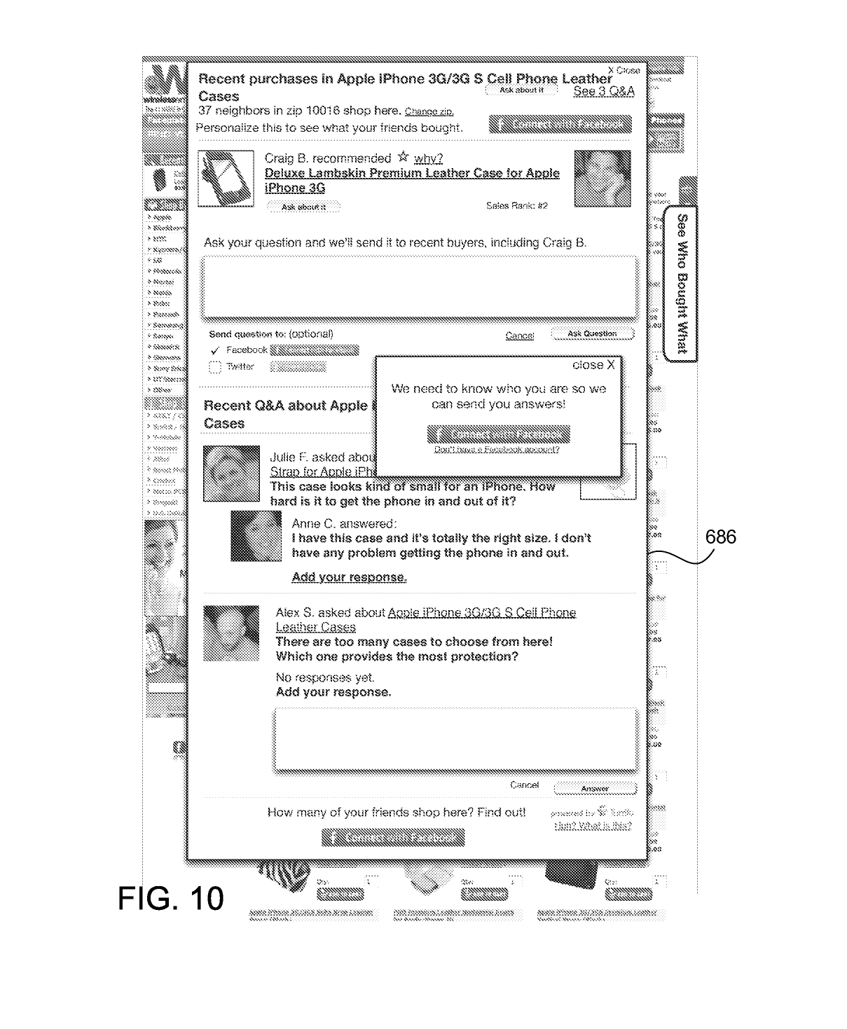

FIGS. 9 and 10 show overlays 684 and 686 that are similar to ones illustrated in earlier figures. Here, however, the entries displayed in each overlay have not been chosen with respect to available entries for the entire site, but with respect to a specified category of product (here Apple iPhone 3G/3GS cell phone leather cases), as indicated in the title of the overlay.

As shown for these overlays and others previously described, entries that report on people who recommended a product include a link “why?” That, when invoked, causes a display of the reason for that person's recommendation.

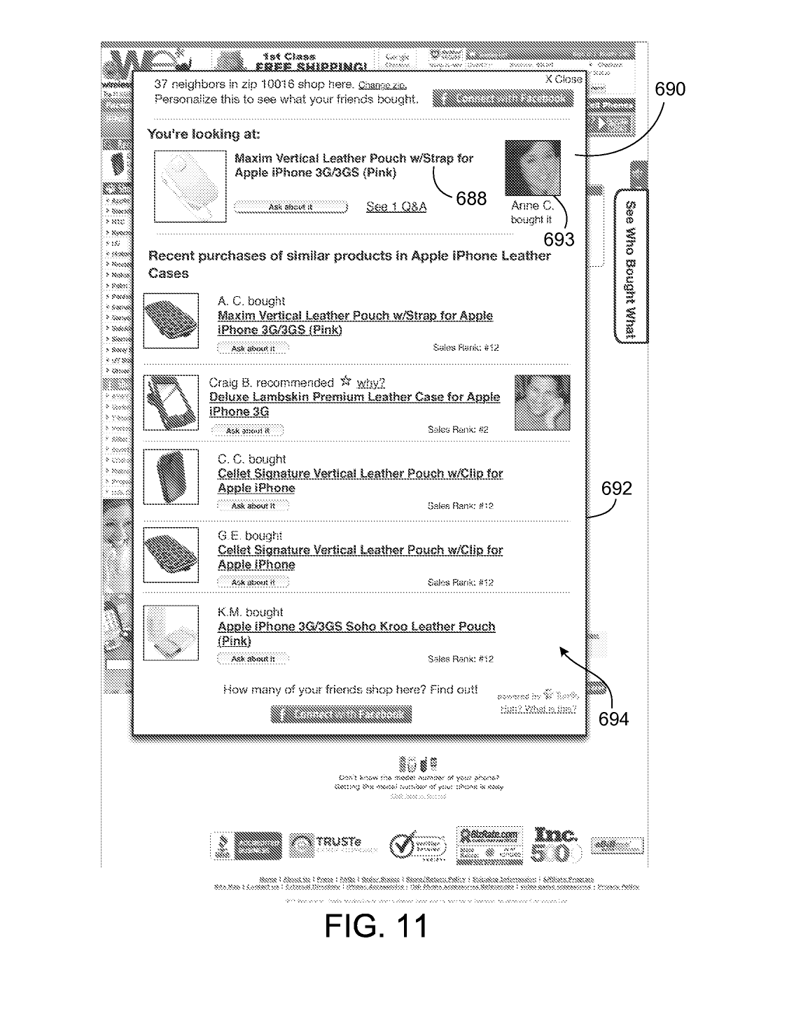

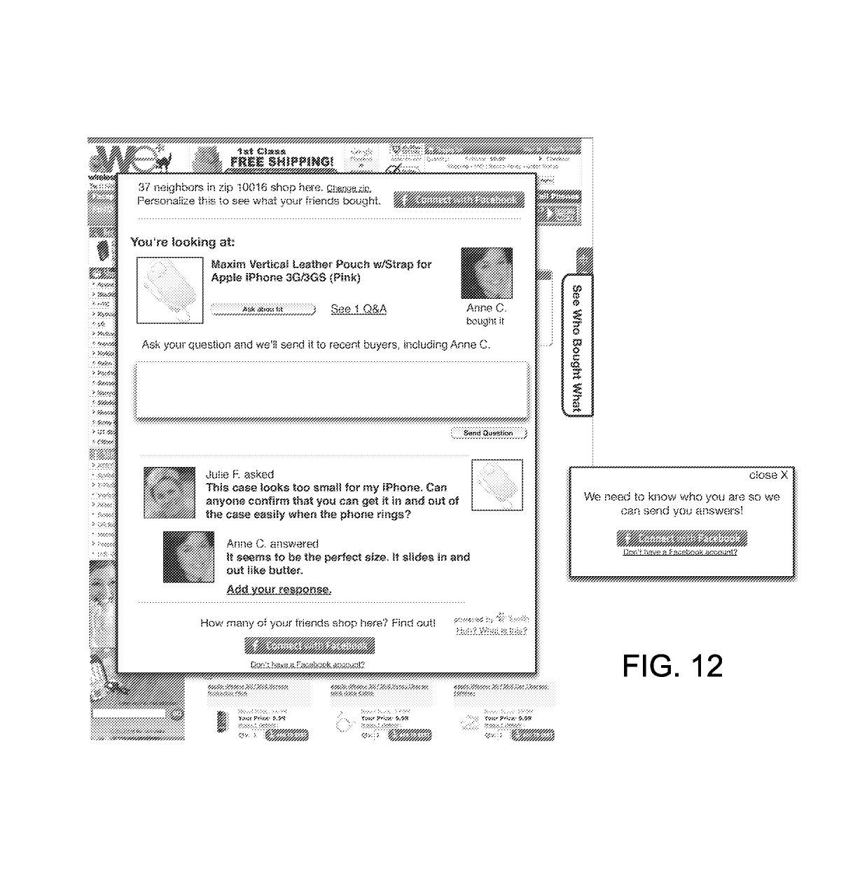

FIGS. 11 and 12 show similar overlays, but in this case the entries are focused on a specific product. The product is identified 688 in the top entry 690 of the overlay 692 on figure J. That entry also shows a thumbnail picture 693 of a person who bought the item. (Similar thumbnail images appear on entries shown on other figures.) Subsequent entries 694 of the overlay identify purchasers of similar products.

Note that in the figures discussed above, a shopper is given access to anonymous information about users who were purchasers of products at the site, without the system knowing that any of those purchasers is a contact or friend of the shopper.

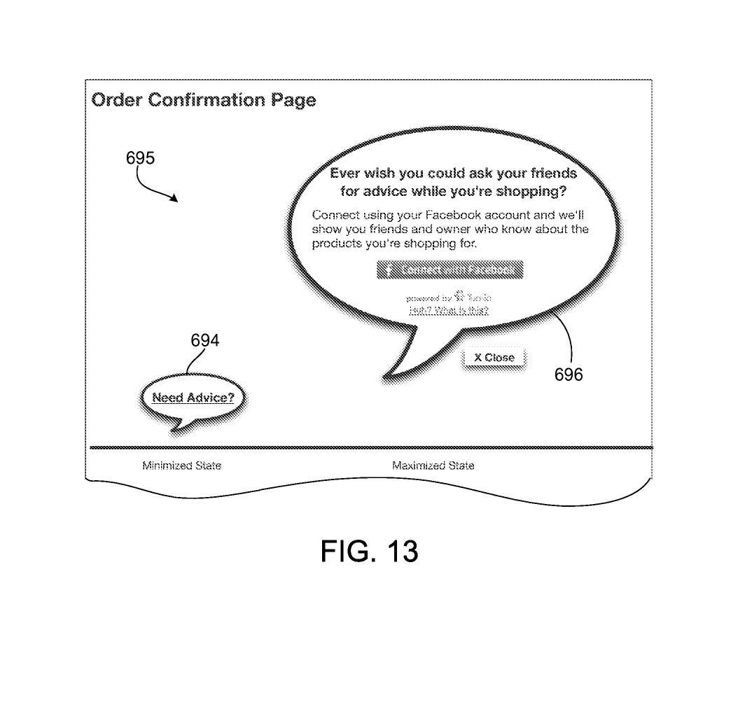

FIG. 13 illustrates the callout 695 that would be shown to an unregistered user on the order confirmation page for a product that the user bought. Initially, the callout would appear minimize 694. Clicking on the callout would enlarge it to the maximized state 696.

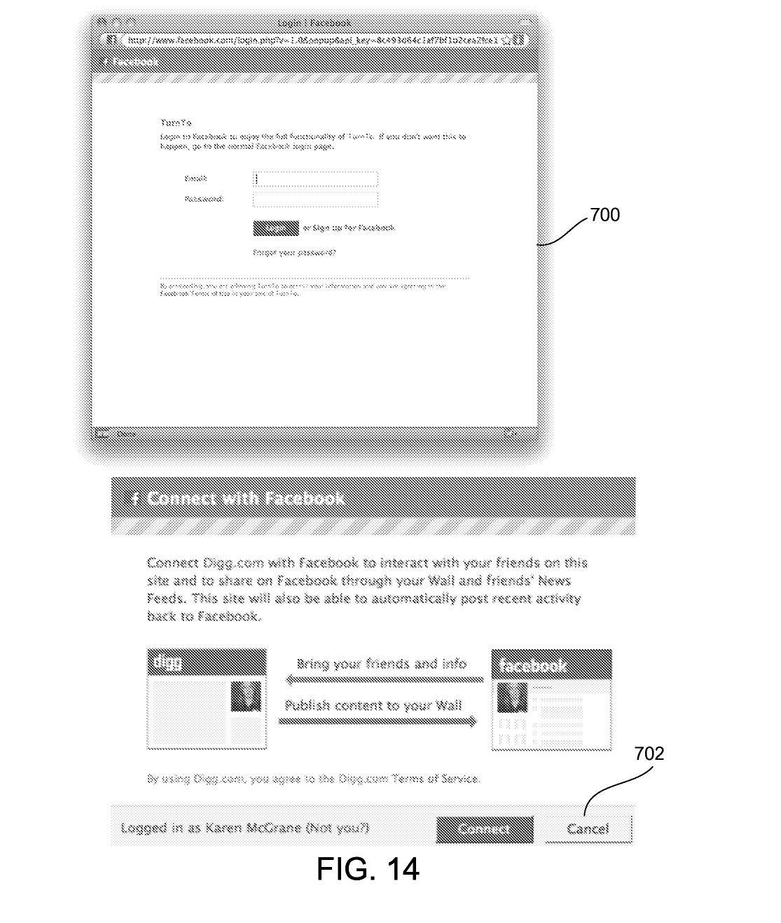

We turn now to the screens that are shown to the user during registration or sign up for the features being discussed above and below. The registration process is entered when the user invokes any of the “Connect with Facebook” links on any of the other screens. Invoking one of those links leads to the social networking site's login screen 700 on FIG. 14, where the user is invited to enter his email address and password for the social networking site. Depending on the source site from which the user reached the social networking site, invoking the registration process may lead instead to the login screen 702 on FIG. 14.

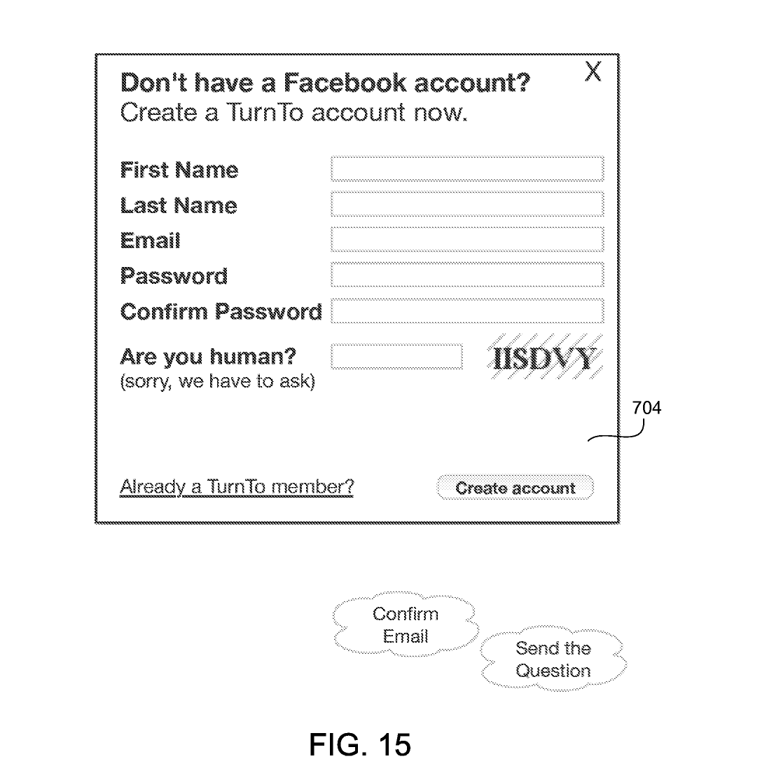

If the user does not have an account with the social networking site, an overlay 704 as shown in FIG. 15 is presented, enabling the unregistered user to create an account with the system host. Creating the account requires entering the user's name and email address. Creating the new account is beneficial to the social networking site, the registering user, the system host, and the site on which the shopper is active.

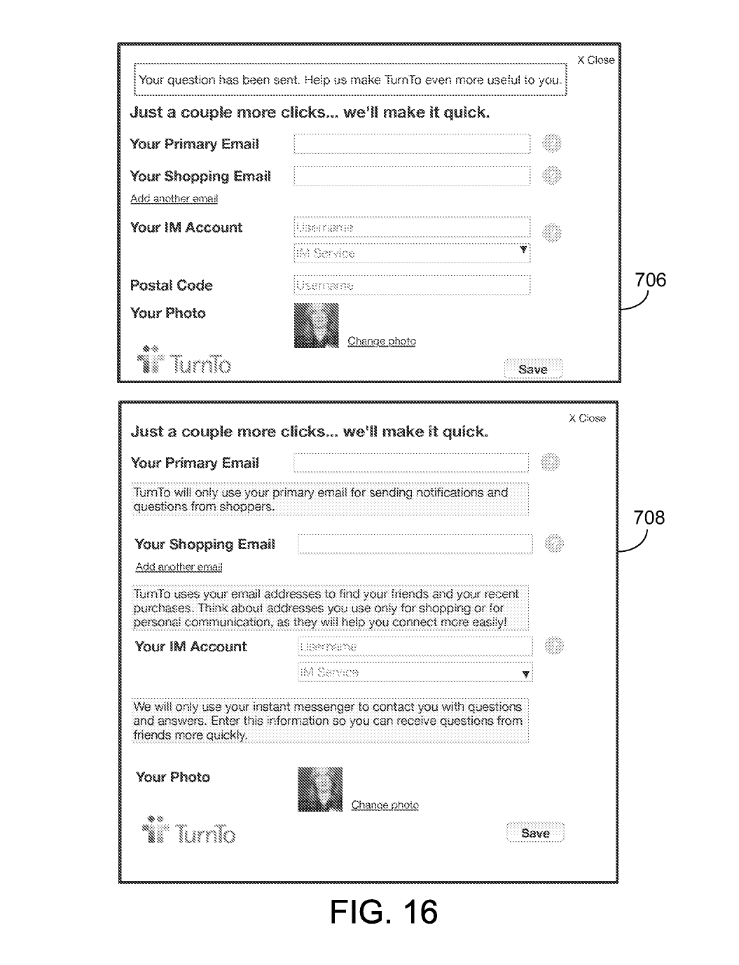

FIGS. 16, 17, 18, and 19 show forms that may be displayed during the course of registration flow, either as a widget overlay or embedded on a page on the affiliate site. When the user clicks on the social networking site connect button, he is first taken to the form shown in FIG. 14, then comes back to the form shown in FIG. 16. If the user registers in a traditional way, he starts with FIG. 15 instead of FIG. 14 and then goes on to FIG. 16.

When, for example, the ask link 664 on FIG. 7 is invoked, the overlay 623 will appear. If the user clicks on the button 622, then the dialog 700 of FIG. 14 appears. If the user clicks the “Don't have a FaceBook account?” link 625 on FIG. 7, the dialog of FIG. 15 appears. Becoming authenticated in this way is a less engaging step than signing up or becoming registered. In the overlay 706 of FIG. 16, the user enters email addresses and an instant messaging address, which can be used for sending questions to the user or sending replies to questions of the user. The user is also asked to provide a postal code which enables the system server to group people by location so that the transaction information may be selected to be more relevant to the user. The shopper can also add or change a photograph. The entered postal code can also used for the purpose of showing how many shoppers have a similar location to the user. The photograph thumbnail can be displayed in entries of overlays, as discussed earlier.

The overlay 708 is similar to the overlay 706, and shows information that is provided when help buttons are invoked.

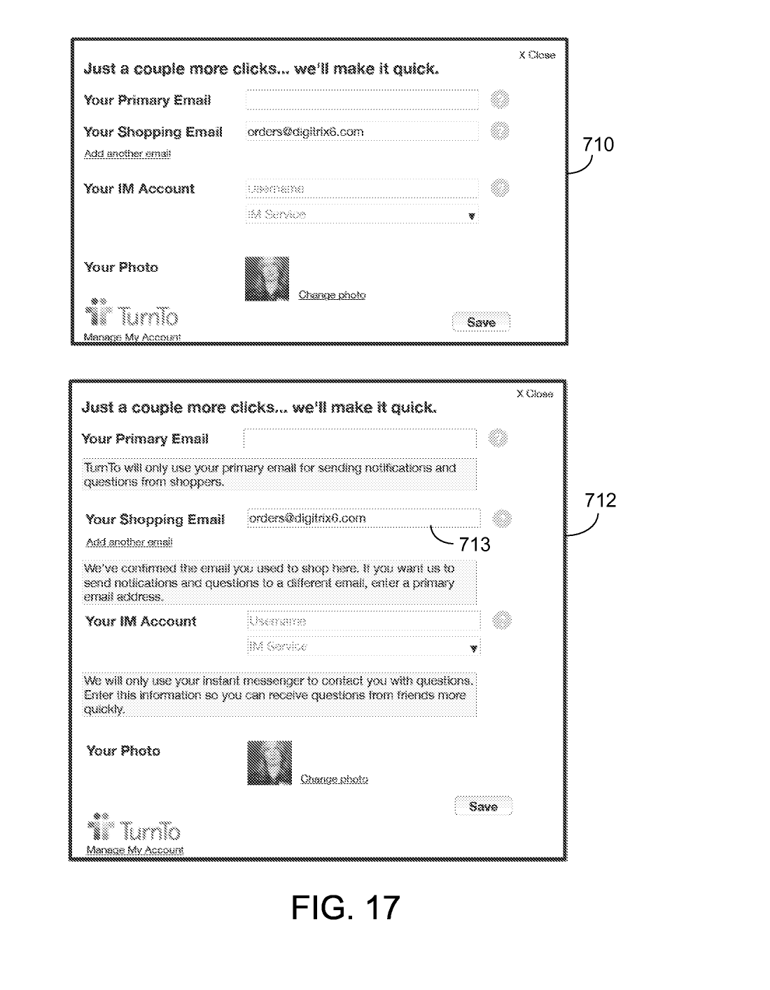

FIG. 17 shows that similar overlays 710, 712 are presented to the user immediately following a purchase on the site. In these cases, the shopping email of the user 713 is pre-completed from information already known to the site.

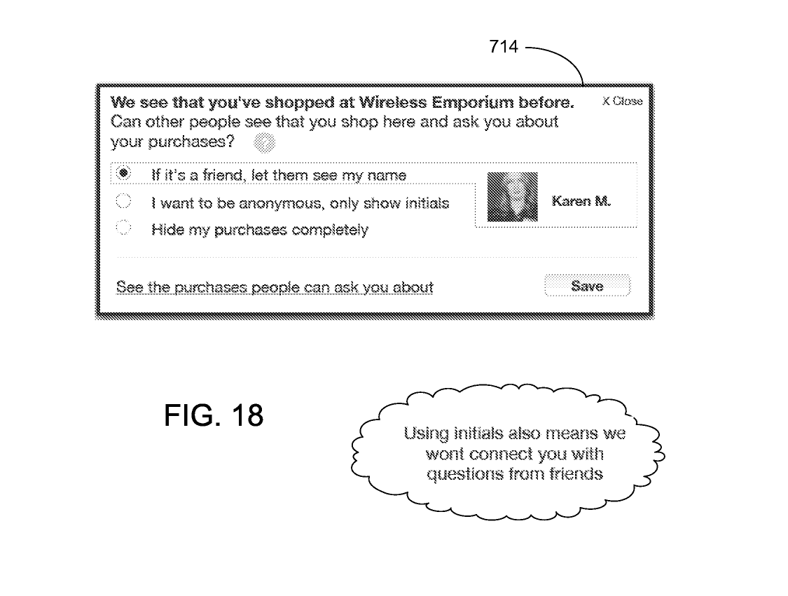

Once the user has completed the overlays of FIG. 17, the overlay 714 of FIG. 18 is presented. This overlay asks the user to permit display, to other users of the site, of the fact that he is a user of the site, and also to permit questions about his purchases to be posed to him. A set of radio buttons 716 enables the user to choose settings for this feature. This information provides the permissions necessary to allow at least some of the display features previously described, with respect to other users of the site, who are not participants in the host system.

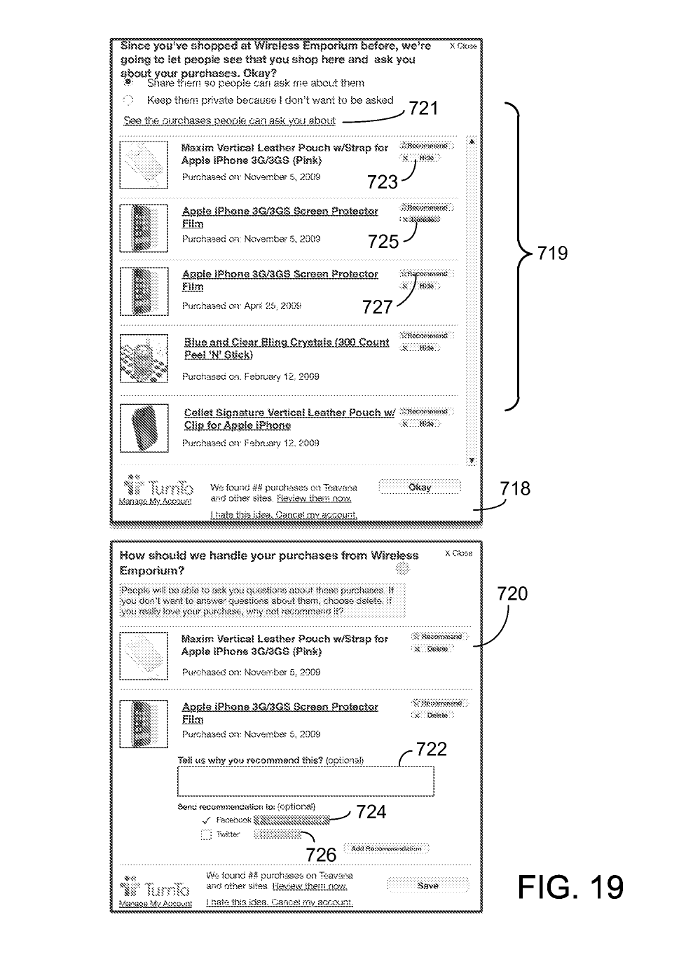

FIG. 19 shows an overlay 718 that contains entries 719 each of which corresponds to a prior purchase of the user. These entries appear when the link “see the purchases people can ask you about” 721 has been invoked. This enables the user to decide how to respond to the invitation to expose the information to others. In addition, toggling “hide” and “unhide” buttons 723, 725 enable the user to select which transactions to expose, for each transaction independently.

Each of the items on overlay 718 is accompanied by a “recommend” button 727. When the recommend button is invoked, the item for which the button was invoked is expanded to include a text entry box 722 on an overlay 720. The user can give a reason for his recommendation, which will then be displayed when other users request it, as described earlier. Additional links 724, 726 permit the user to send the recommendation to selected other social networking sites.

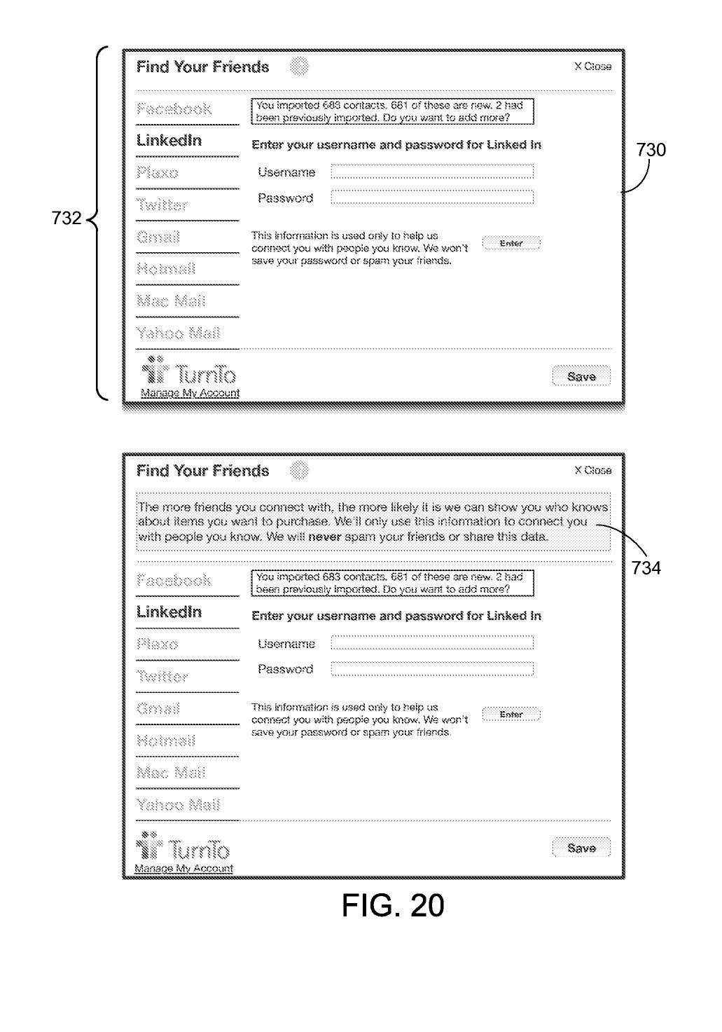

An overlay 730 shown on FIG. 20 encourages the user to find friends on other social networking and email sites 732 by entering his user name and password for each selected other site. A user confidence building message 734 is displayed when the user invokes the help button.

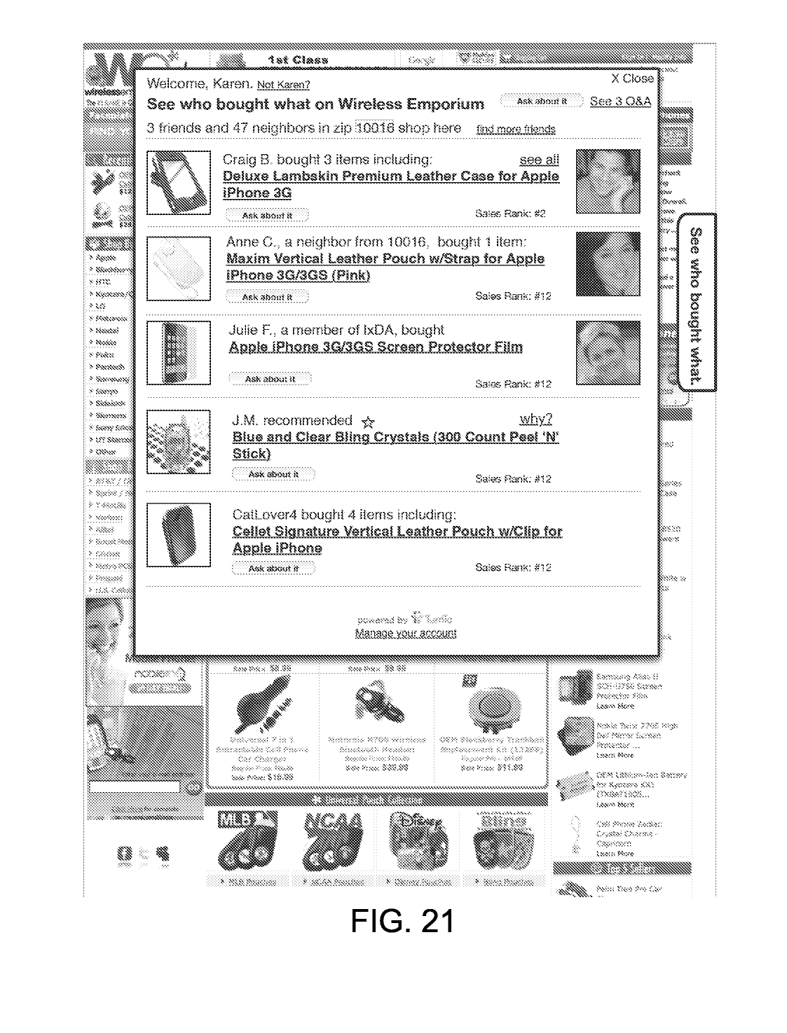

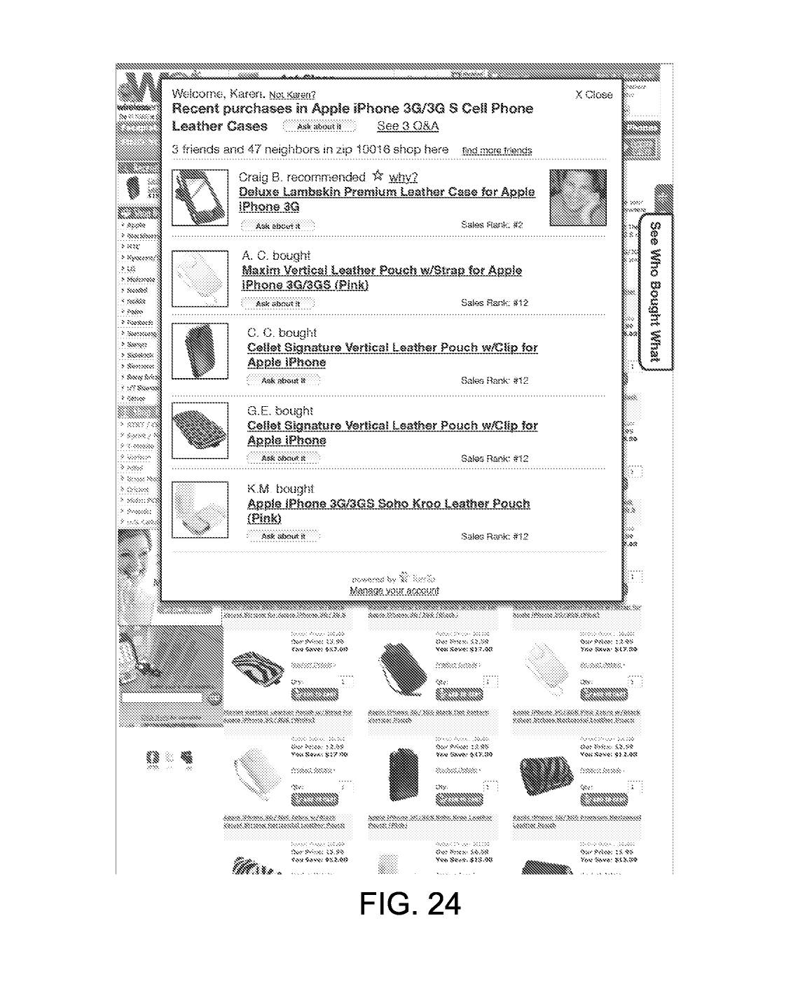

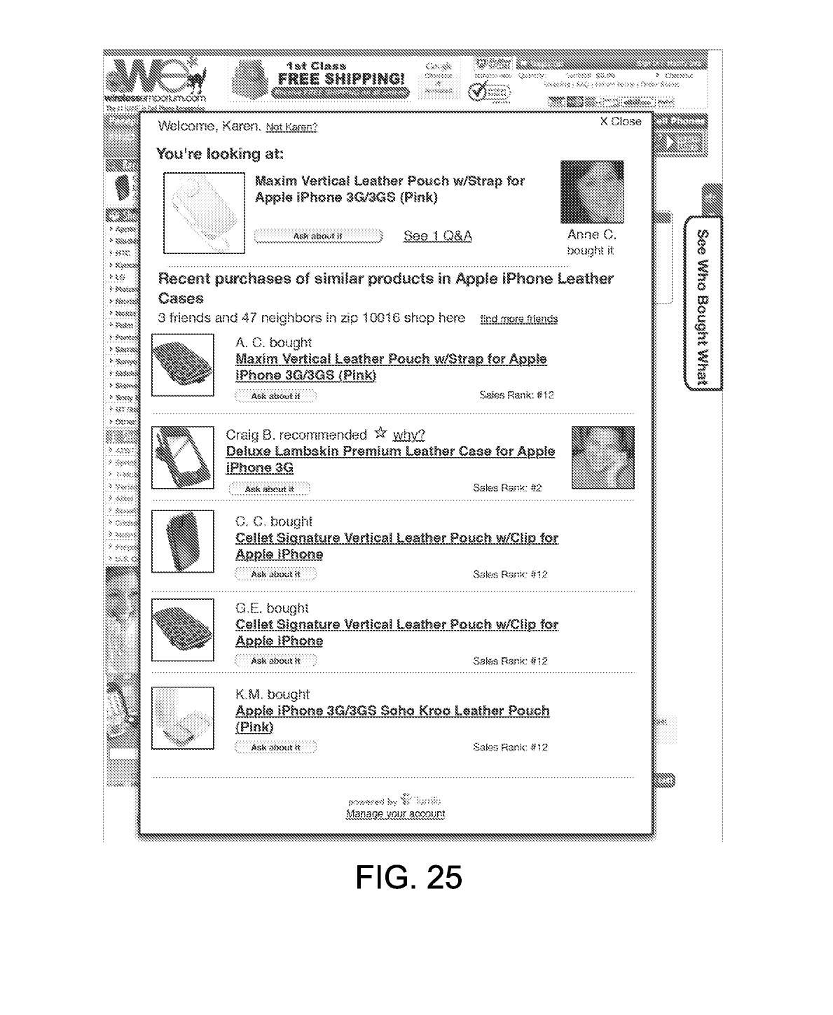

FIGS. 21 through 25 shows similar overlays that are presented to a user, once he has completed the registration process, at a site level (that is, with respect all related purchases made by other users of the site, FIGS. 21, 22, 23); at the category level (that is, with respect to purchases made by other users of the site same category of product, FIG. 24); and the item level (that is with respect to purchases of exactly the same product by other users of the site, FIG. 25).

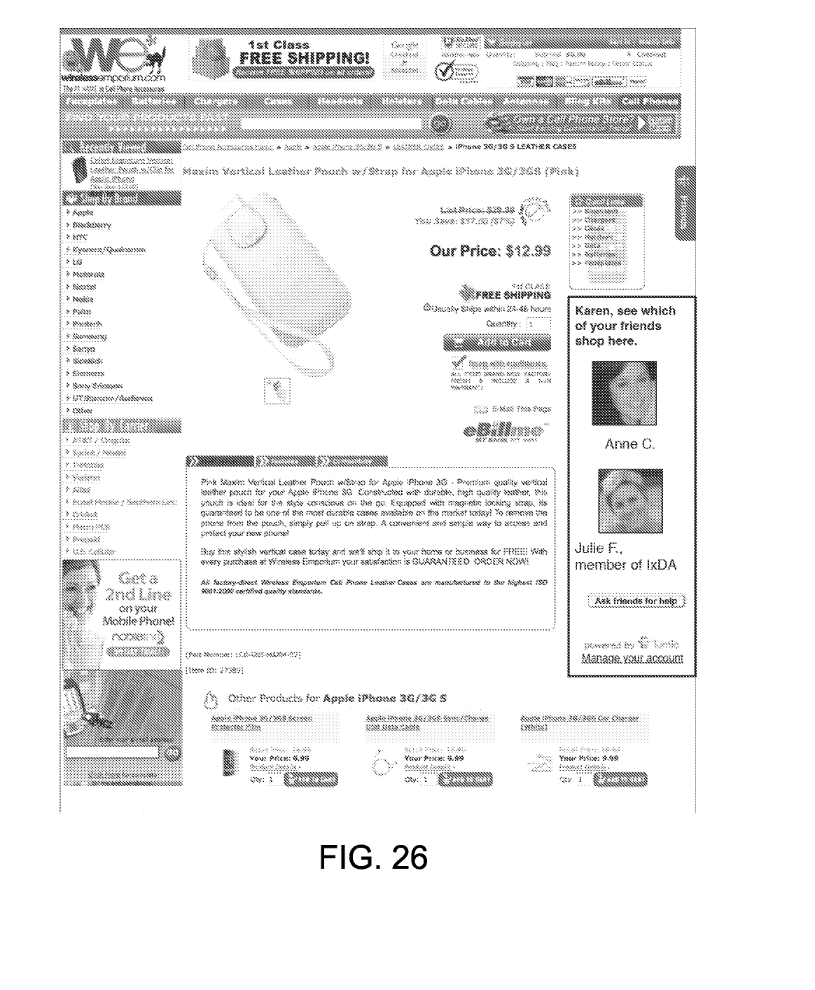

A sidebar 736 on FIG. 26 illustrates another way to display information about friends who use the same site without overlaying the main portion of the page.

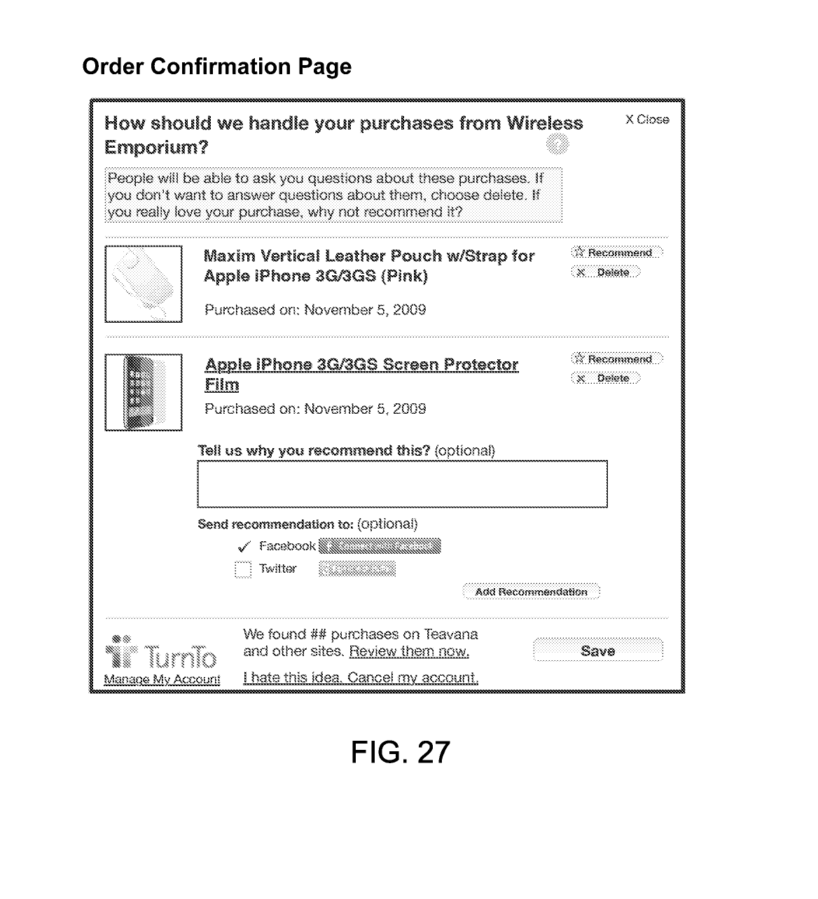

As shown in FIG. 27, the same overlay 720 of FIG. 19 can be shown as an overlay on the order confirmation page when a user makes a purchase. In this case, the initial display would be of a minimized control (not shown) that, when invoked, would open to the full form shown in FIG. 27.

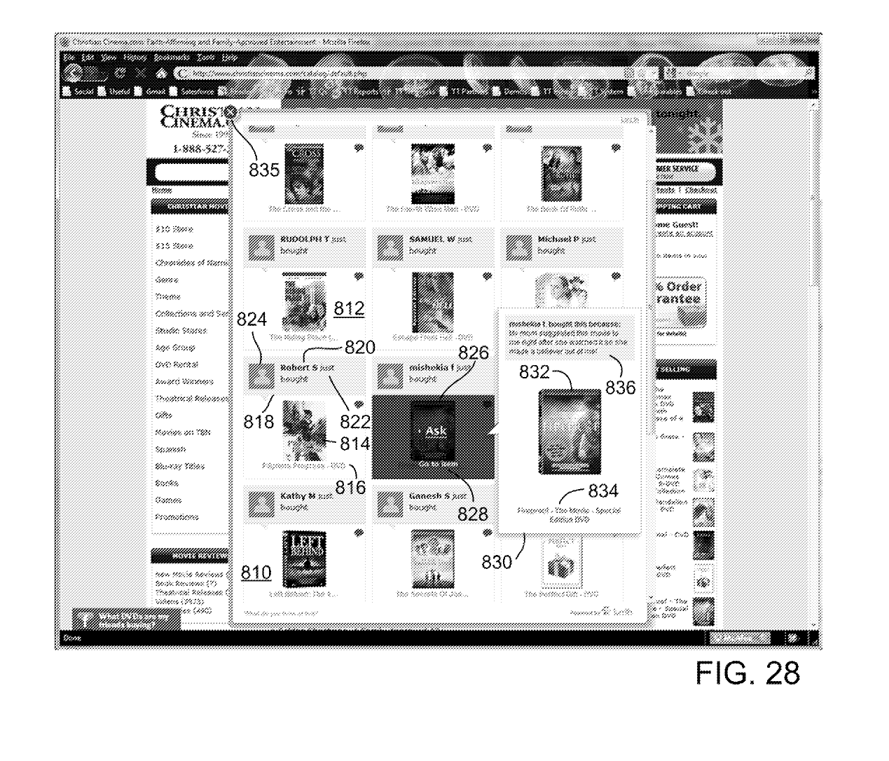

The screenshots shown in FIGS. 28 through 49 illustrate other examples.

As shown in FIG. 28, a user of the ChristianCinema.com website is interested in getting a sense of what movies other customers are buying, what movies her friends are buying, and why. As a result, a panel 810 has opened and overlays the webpage of the host site. The overlaid panel displayed a matrix of sub panels 812. Each of the sub-panels displays a thumbnail image 814 corresponding to a cinema, the title 816 of the cinema, and a header 818 that provides a shortened version of a name 820, a message 822 that identifies an activity of that person with respect to the cinema represented by the sub-panel, and an icon 824 representing an image of the person or a photograph of the person.

If the user of the site rolls her mouse pointer over the thumbnail for one of the cinemas, that portion of the subpanel changes to display a link 826 entitled “ask” and a second link 828, entitled “go to item”. In addition, a new sub-sub-panel 830 open next to the subpanel that has been invoked. The sub-sub-panel displays the icon for the cinema 832 and its description 834 and provides a header 836 indicating, in the words of the identified purchaser (in this case mishekia f), why she bought that cinema. The words of the purchaser were provided to the system earlier by the purchaser, for example, at the time of purchase. Displaying to the user this information about why the prior purchaser bought the cinema can be very useful, especially because a prior purchaser tends to be a credible source of information concerning the cinema.

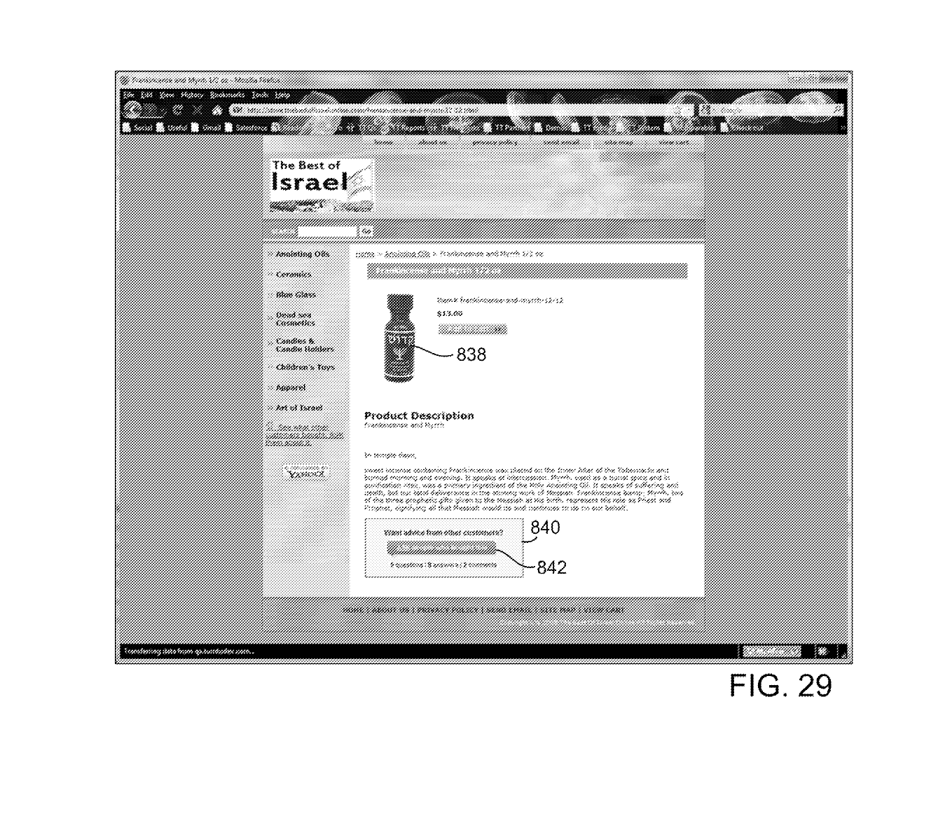

FIG. 29 shows another mechanism that enables the user of a site in which products, for example, are displayed (e.g., because they are offered for sale), to get information about the product from credible sources. In this case, a user of the site thebestofIsraelonline com is being shown a product 83 called Frankincense and Myrrh in a manner that is typical of commercial websites. At the bottom of the product description, a small panel 840 invites the user to ask for advice from other customers.

The other customers could be people who have purchased the product from this website, people have purchased the product from other websites, people who have used the product, people who have some credible understanding about the product, and people who have done any or all of those things with respect to other products that may have been related to this product, for example because they are part of the same class of products or group of product. In some implementations, when we speak about a product we are referring to a product at a level of granularity typified by the SKU numbers used in retailing. Therefore a product class could be a set of products of essentially the same type, packaged differently or indifferent numbers of units, for example. Other numbering and product categorization approaches could also be used.

Within the panel 840, a button 842 can be invoked by the user, for example, to ask people who have bought that product on this site a question that might provoke useful answers for the user. A legend 844 underneath the button entices the user to invoke the button by reporting that other users have previously asked of nine questions about the product and the nine answers and two comments have been posted about the product.

(Many of the panels and subpanels discussed here include an X control 835 in the upper left-hand corner or other location. At any time, the user of the site can click the X to make the panel are subpanel disappear.)

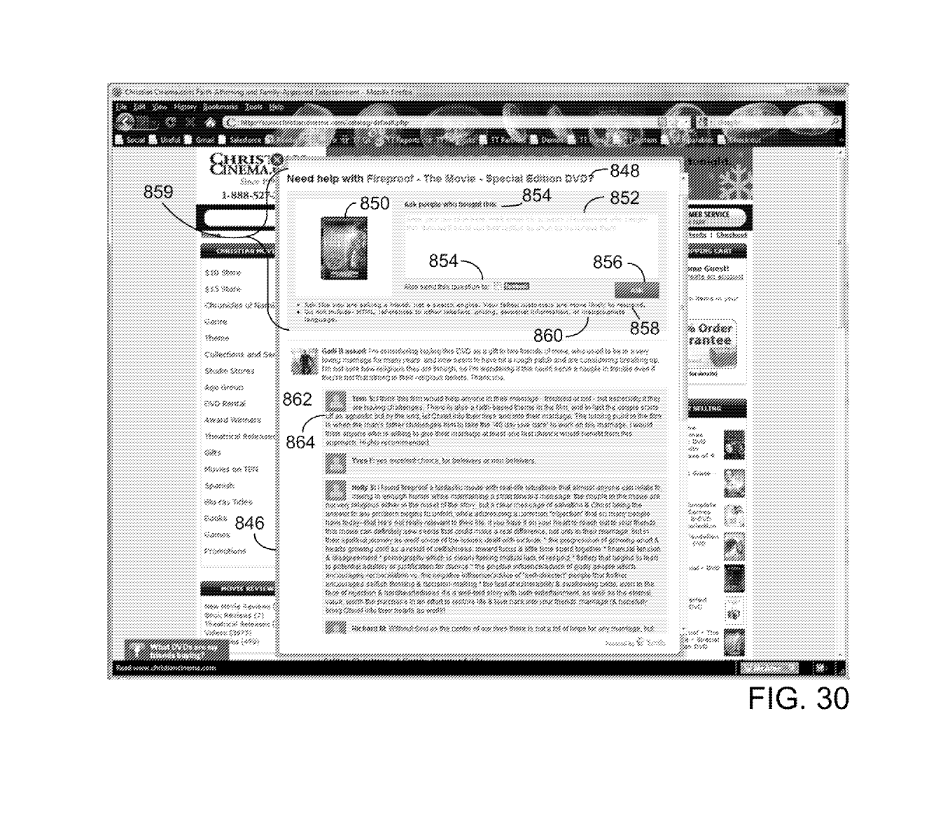

Returning to the example of FIG. 28, if the user invokes the ask length 826, the overlaid panel changes to the panel 846 shown in FIG. 30. (We sometimes refer to this panel 846 as the “ask widget.” A header 848 contains the name of the product and a notice to a user that help is available. The icon 850 associated with the product is also shown. A subheader 851 invites the user to ask a question of people who bought the product. A text entry box 852 provides a place for the user to type the question. The user is invited 854 also to send the question to a social networking site to which the user may belong. A button 856 enables the user to send the question to the system. A message 858 advises a user that she should ask the question in a conversational way. Another message 868 cautions against including certain information in the question. The panel also shows a question 862 previously asked by another user about this product. Answers to that question 864 by multiple people who had bought the product are also shown.

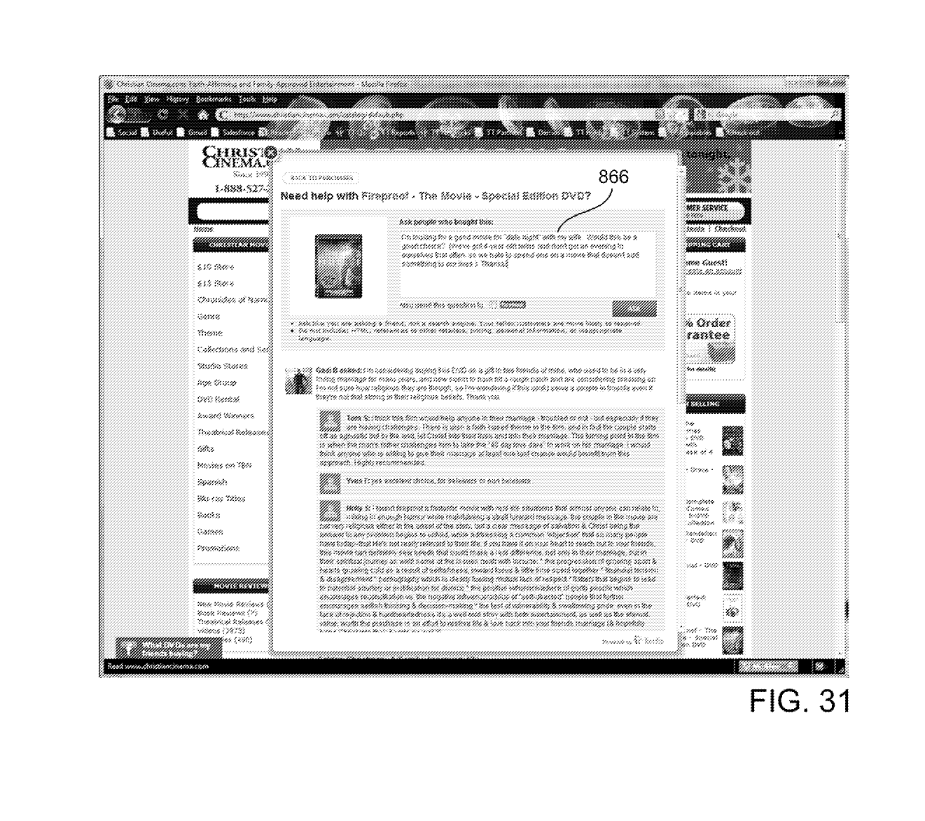

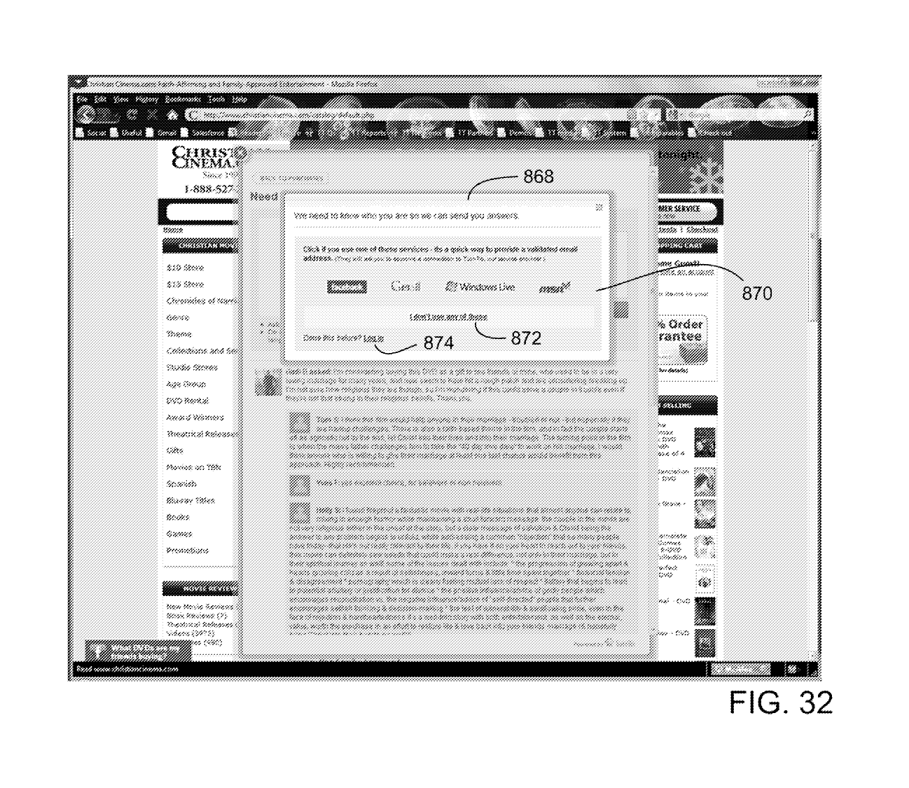

In FIG. 31, a question 866 has been entered. In some cases the user who asked the question has not registered her e-mail address with the site. In such cases, as shown in FIG. 32, a subpanel 868 is displayed advising the user that the system will need to have an e-mail address or other location to which to send the answers. The user is given the opportunity 870 to identify sites that she may already use and that may be contacted to provide the e-mail address easily. Conversely, a link 872 is provided for a user who does not subscribe to any of the indicated sites. By invoking the link 872, the user is given the opportunity to register her e-mail address with the site.

For a user who has already registered, a link 874 enables the user to login as a way to indicate to the Q&A system who she is.

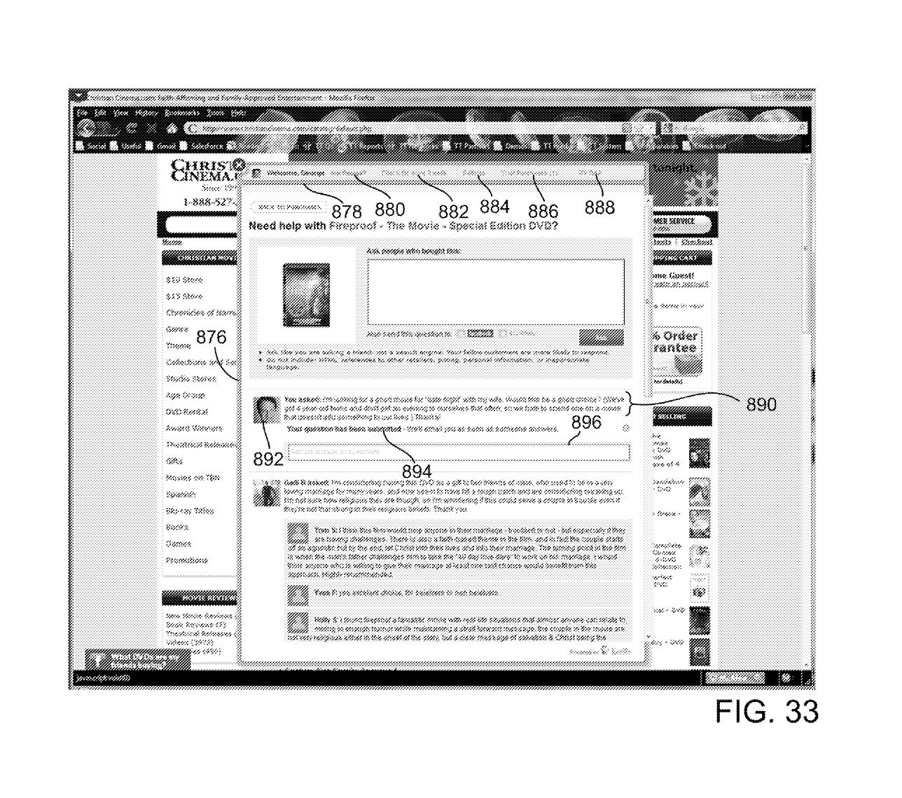

After the user has entered a question and her e-mail address has been identified by the system, the system displays a panel 876 shown on FIG. 33. Panel 876 includes the header 878 which now identifies the person by name (in this case, the user's name is George.) The header also provides other links. Link 880 enables the user to login as someone else. Link 882 enables the user to hunt for friends. Link 884 allows the user to control the settings for this feature. Link 886 recounts the user's purchases. And link 888 directs the user to information about his questions and answers posed on this site, for example.

The user's entered question 890 is displayed back, with the user's image thumbnail 892 and a notation 894 confirming that the question has been submitted and the answers will be returned as soon as they're available. Text entry box 896 permits even the user to add a comment to the question.

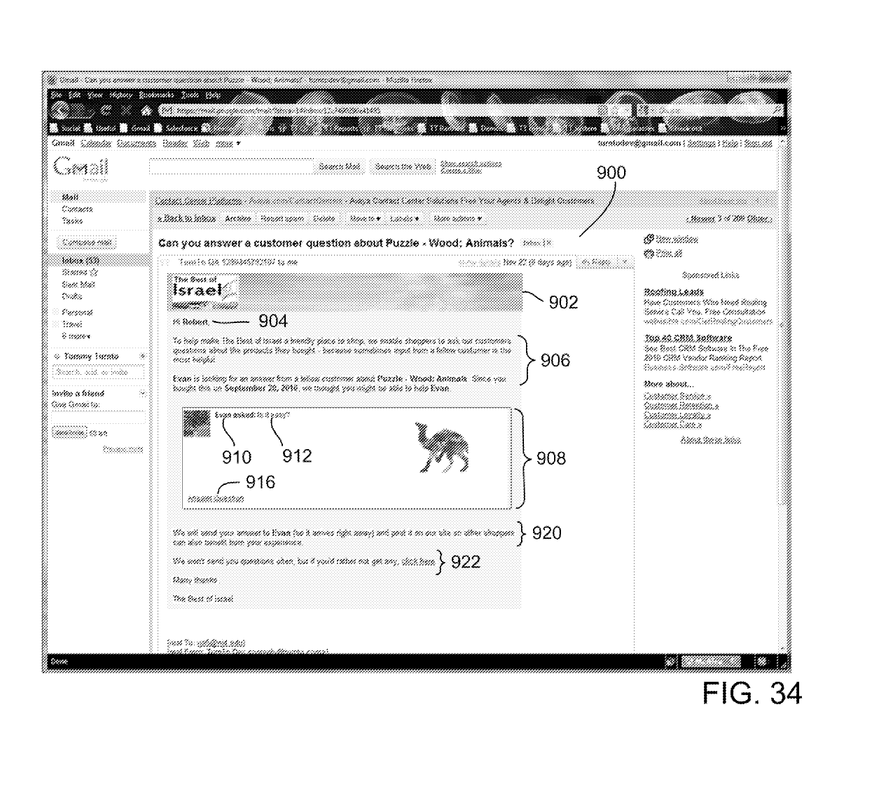

FIG. 34 illustrates, with respect to the Israel site, an example e-mail 900 that would be sent to a prior purchaser of a product to pose a question asked by a current user of the site. The e-mail includes a banner 902 that is associated with the site. This is advantageous to the merchant, of course. The e-mail message includes a personal greeting 904, an instruction 906, and A box 908 containing the name of the user and the question that he asked 912. A thumbnail 914 of the product is also shown. A link 916 is provided for the recipient of the e-mail (that is, the person who purchased the product and is answering the question) to invoke in order to answer the question. A statement 920 explains what will be done with the answer and a link 922 enables the recipient to opt out of receiving any such request. A recipient of such an e-mail would typically have registered his e-mail address with the site, and would have not opted out of receiving e-mails from the site. By clicking on link 922, the user can either opt out of receiving any e-mails from the site or opt out of receiving this kind of e-mail from the site.

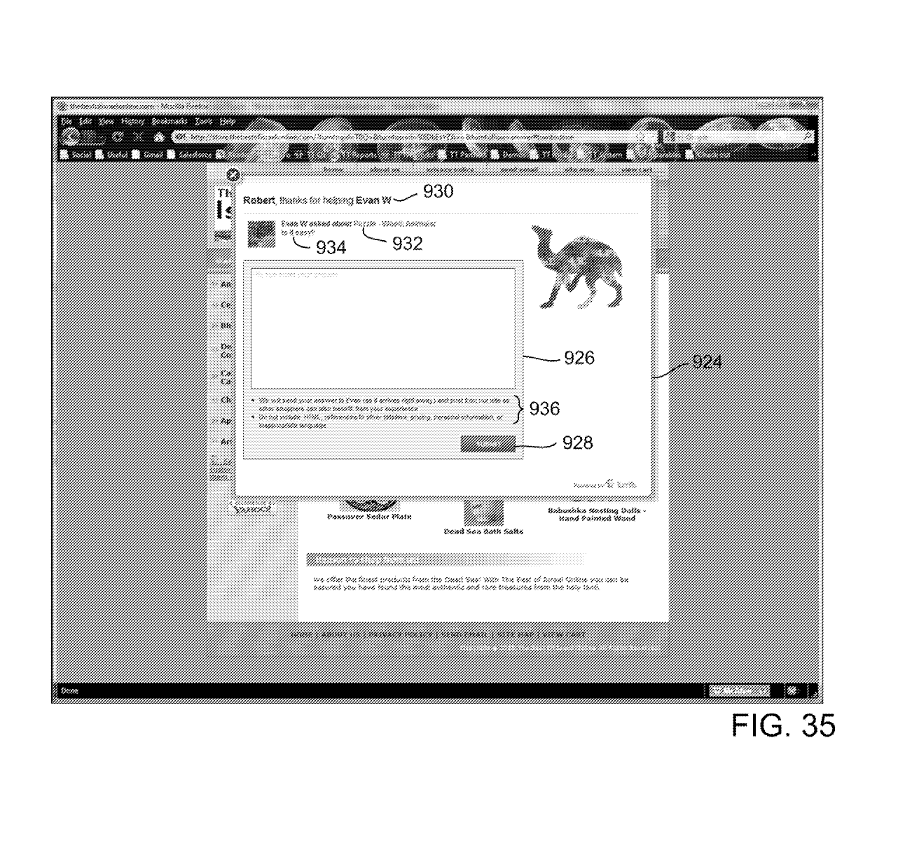

When the user clicks on link 916 to answer the question, his browser is directed to the site that sold the related product. As shown in FIG. 35, overlaid on the webpage of the site is a panel 924 that includes a text entry box 926 where the responder can answer the question. Once the question is answered by typing text in the box, the responder clicks on the submit button 928.

The panel 924 also includes a greeting 932 to the responder, identifying the asker, a field 932 of the product, and the question 934. Panel 924 also contains an explanation and a warning 936.

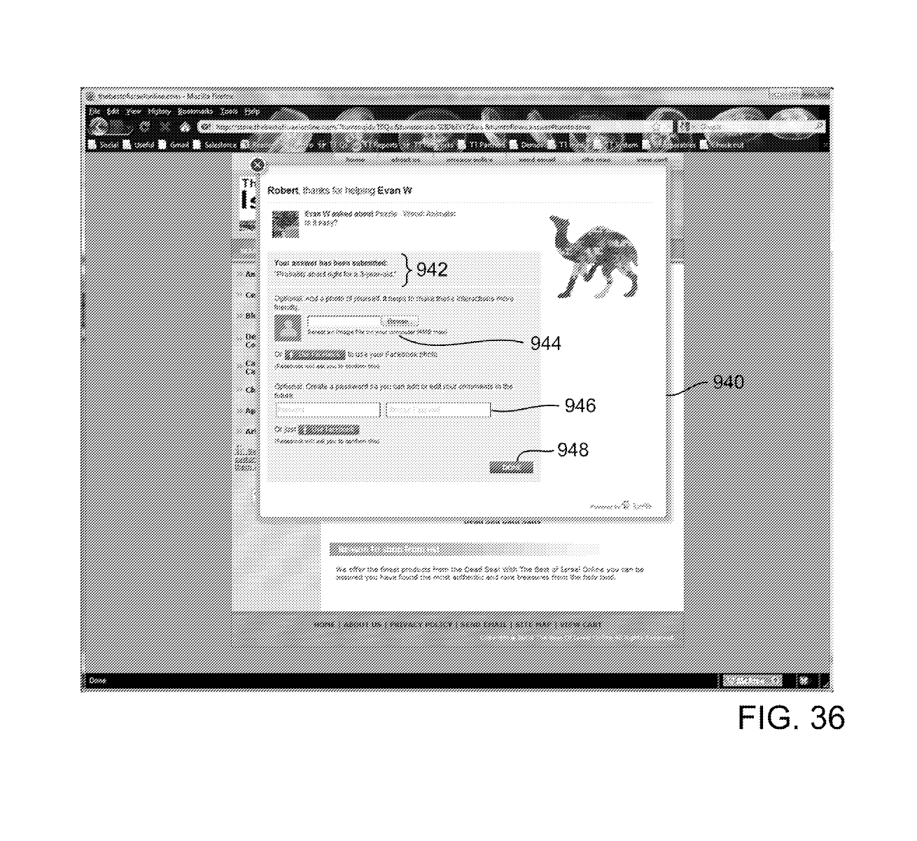

After the responder submits the answer, a panel 940, shown on FIG. 36, is displayed as a confirmation of the answer that has been provided 942. The user can choose a photograph to be associated with the answer 944 and can create a password 946 to be used in further adding to or editing his comments or answers. In effect, the responder is, in this way, registering on the site. When the responder is done with the panel 948, he can click on the done button 948. The

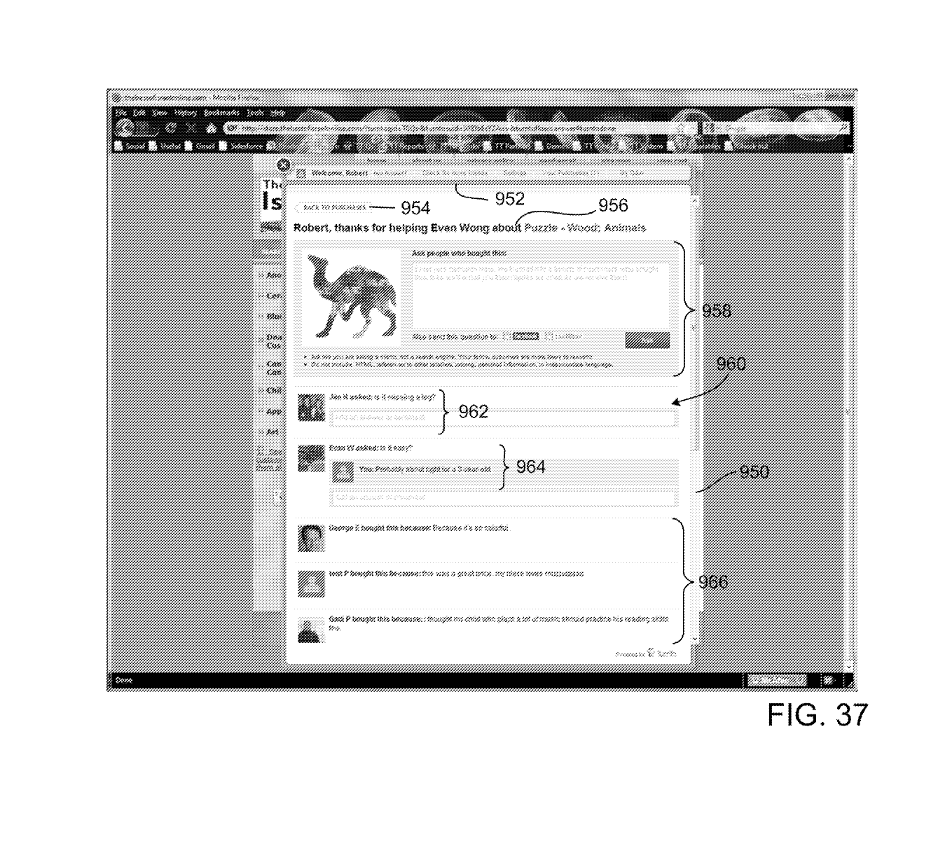

After the done button 948 has been invoked, a panel 950 is displayed, as shown in FIG. 37. This panel includes a header 952 that welcomes the user, a button 954 that enables the responder to return to the normal commercial pages of the website, a greeting 956 that identifies the full name of the asker, the previously displayed question box, and a diary 960 of responses and comments with respect to the product. The diary can include questions 962, questions with answers 964, and comments 966 about why other purchasers bought the product. The diary could include a wide variety of other postings that relate to the product, the class or category of the product, or other matters related to the product, and can also be provided by a wide range of sources including people who purchased the product, people who have some credible information about the product that could be useful for buyers, people who are social networking contacts of the user or of the responder, people who are experts on products of this kind, and others.

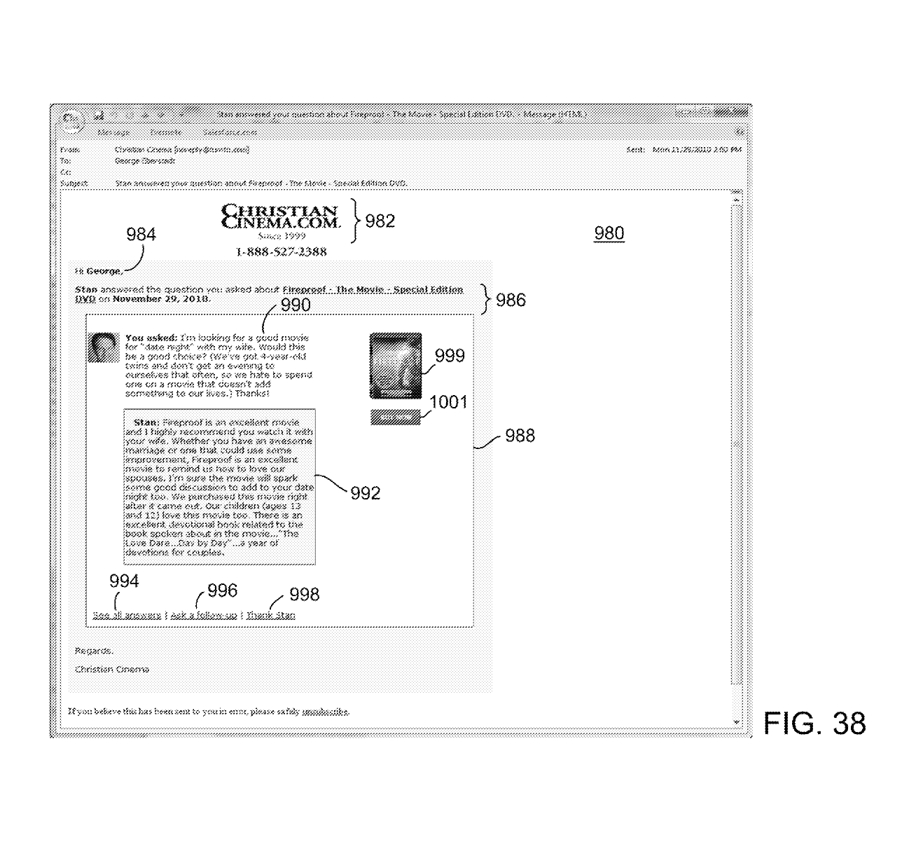

Returning again to the example of the BestofIsrael site, as shown in FIG. 38, after the responder has answered the question, an e-mail 980 is sent in the name 982 of the site where the product is being sold to the asker of the question. This e-mail includes a personalized greeting 984 and an explanation 986 of who answered the question, which products are concerned, and when the question was answered. In a box 988, the question 990 is repeated and the answer is provided. Links 994, 996, and 998 enable the recipient of the e-mail, the asker, to see all answers related to the product, to ask a follow-up question, or to thank the responder. Also within box 988 is an image of the product 999, and a buy now button 1001. Therefore, at exactly the moment when he is presented with his question and the answer from a credible source (in this case a purchaser of the same product on the same site), the asker can immediately buy that product by clicking on the buy now button which takes him to be commercial site. As explained below, this helps to increase the traffic to and purchases at a commercial site. Furthermore, the fact that the buy now button associated visually with the question and answer means that the person who collects the buy now button has already been determined to have a purchase intent. Confirmed purchase intent of a prospective buyer is a valuable asset that can be monetized.

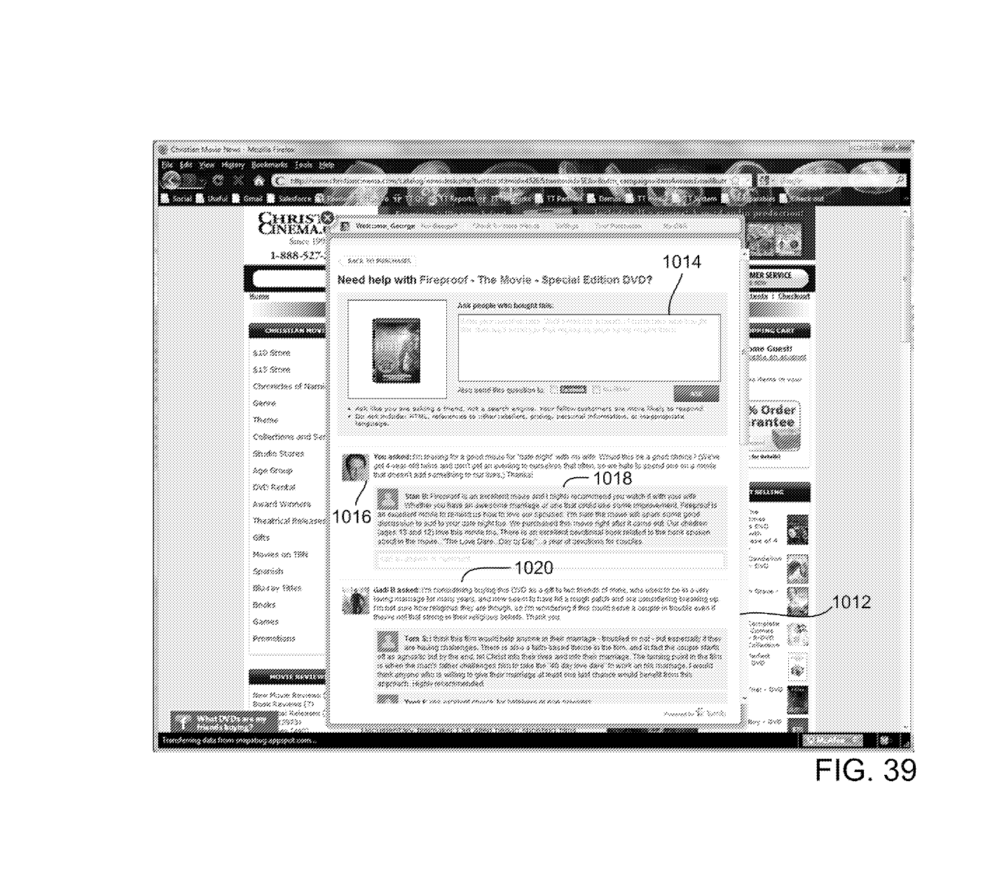

Once the asker is returned to the commercial website, he is presented with a panel 1012 shown in FIG. 39, superimposed on the normal webpage of the site. Panel 1012 presents the usual box 1014 for asking questions (the “ask widget”). In addition, the asker's question 1016 and the responder's answers 1018 are represented along with questions and answers previously obtained by the system 1020.

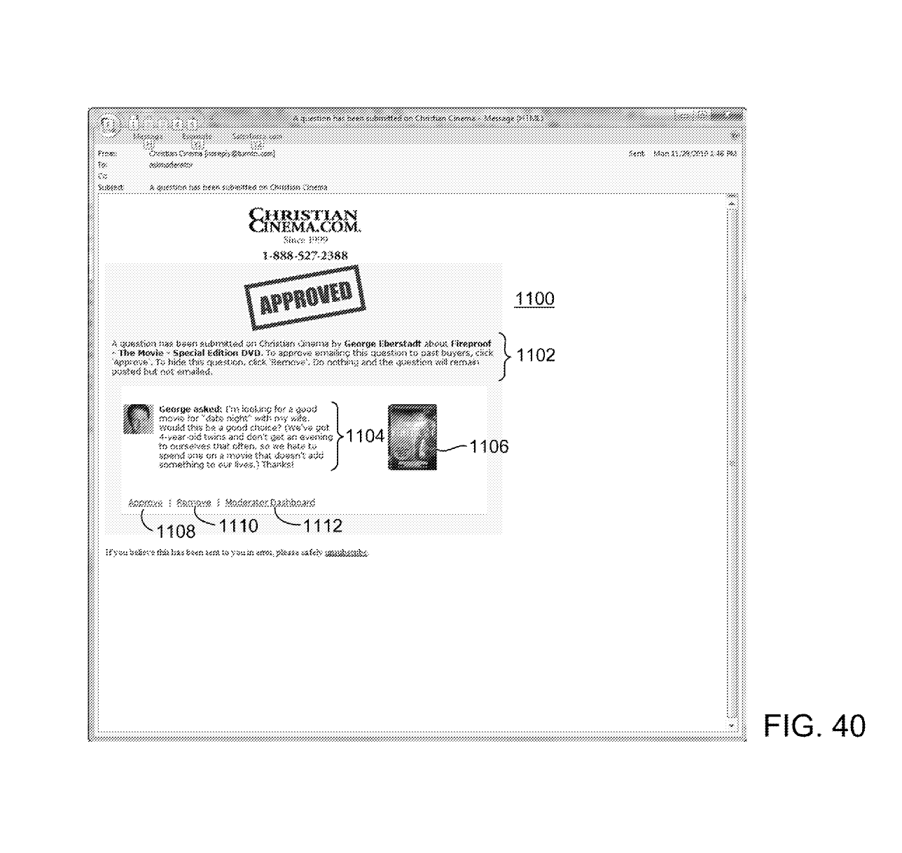

In some implementations of the Q&A system, the question or the answer or both may be moderated to exclude inappropriate content or otherwise manage the content. FIG. 40 illustrates an e-mail 1100 sent to a moderator with respect to a question that has been posed. The e-mail appears under the name of the site from which the question was posed. Instructions 1102 are provided for the moderator. The question is repeated 1104 along with an icon illustrating the product 1106 Links 1108, 1110, and 1112 allow the moderator to approve the question, remove the question, or proceed to the moderator dashboard for other features.

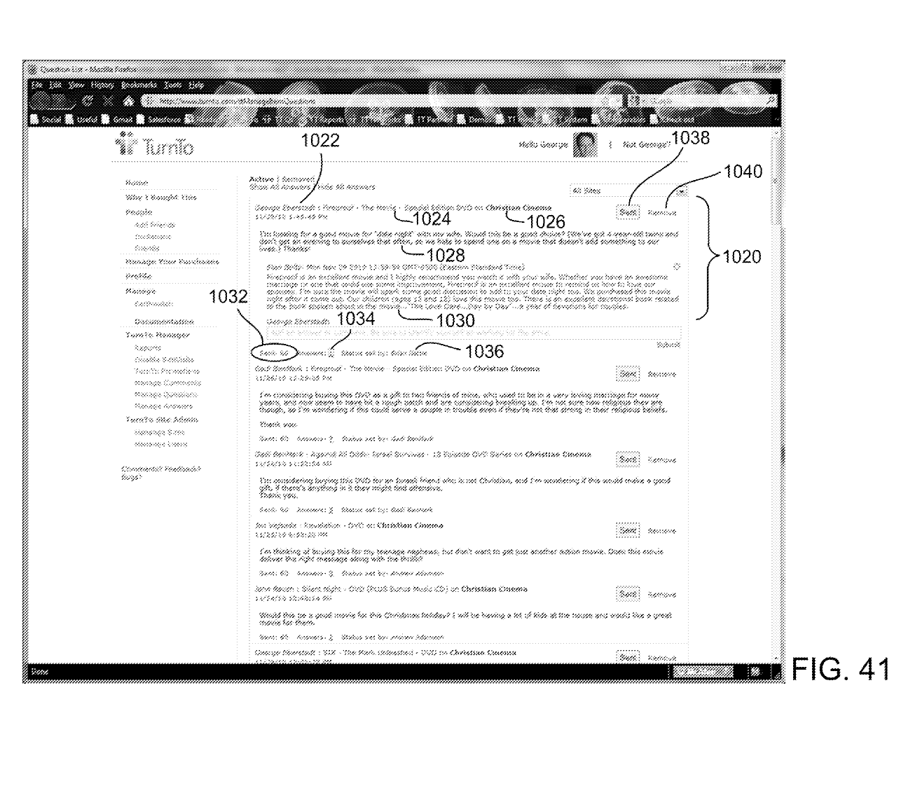

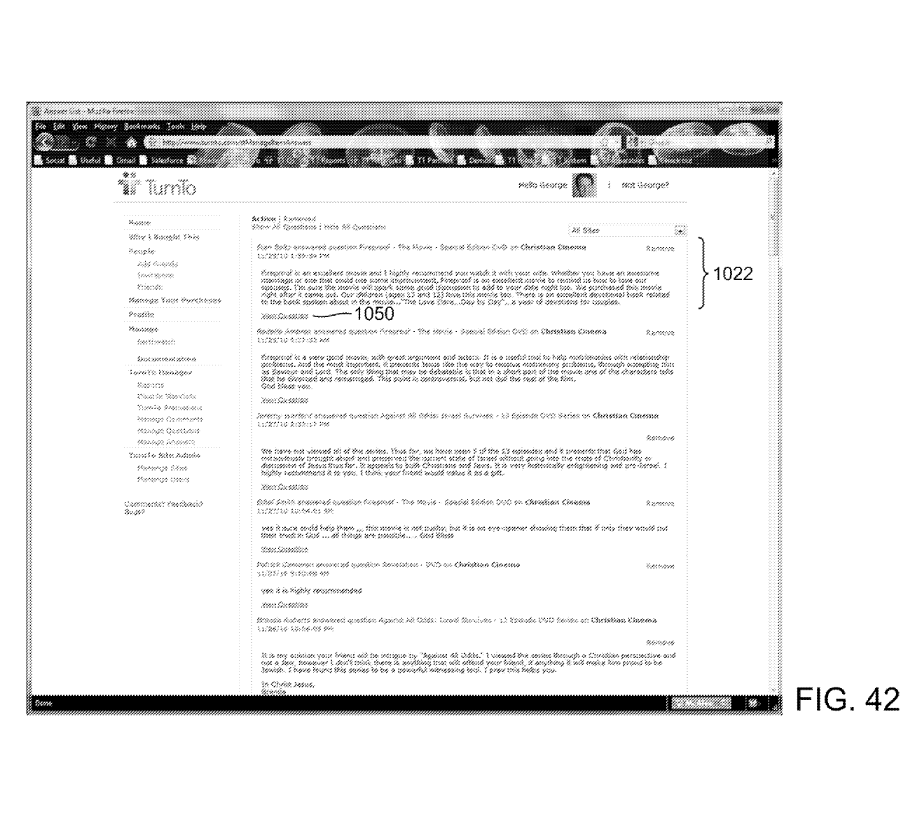

FIGS. 41 and 42 illustrate, respectively, portions of the moderator dashboard that are used to moderate questions that have been posed and moderate answers that have been provided. The moderator dashboard is divided into individual questions 1020 or answers 1022 to be processed. In the case of a question to be moderated, the entry shows the source of the question 1022 the title of the product 1024, the site which was the source of the question 1026, the question itself 1028, and pending answers to the question 1030. The entry also shows the number of copies of the question that were sent to responder's 1032, the number of answers that have been received 1034, and the identity of the moderator 1036. The sent box 1038 indicates whether the question was already sent. The remove link 1040 enables the moderator to remove the question. With respect to moderating answers, similar information is shown, but the moderator has the opportunity to view the question by invoking the view question link 1050.

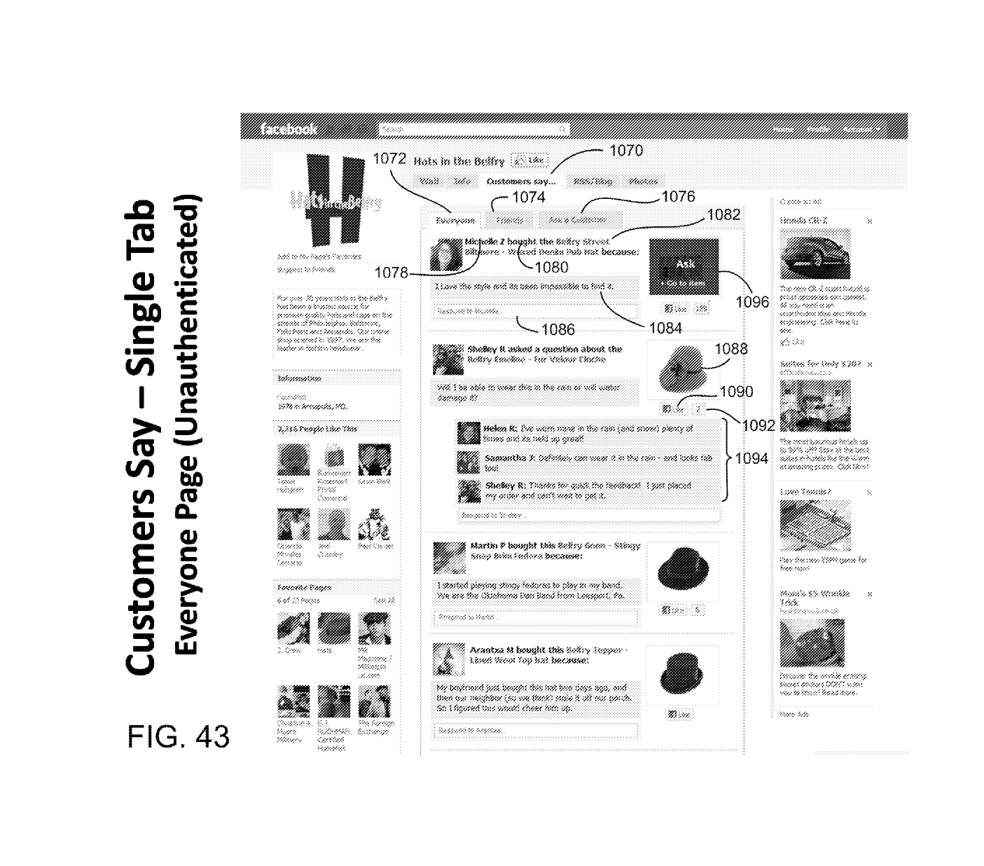

In other examples of implementations of a Q&A system, questions can be asked and answers can be given by postings on the Facebook fan page of the commercial store. For example, as shown in FIG. 43, on the Facebook fan page of the retailer “Hats in the Belfry”, a new tab 1070 (in this case called “customers say . . . ”) and three sub tabs are provided: an everyone sub tab 1072; a friends sub tab 1074; and an “ask a customer” sub tab 1076.

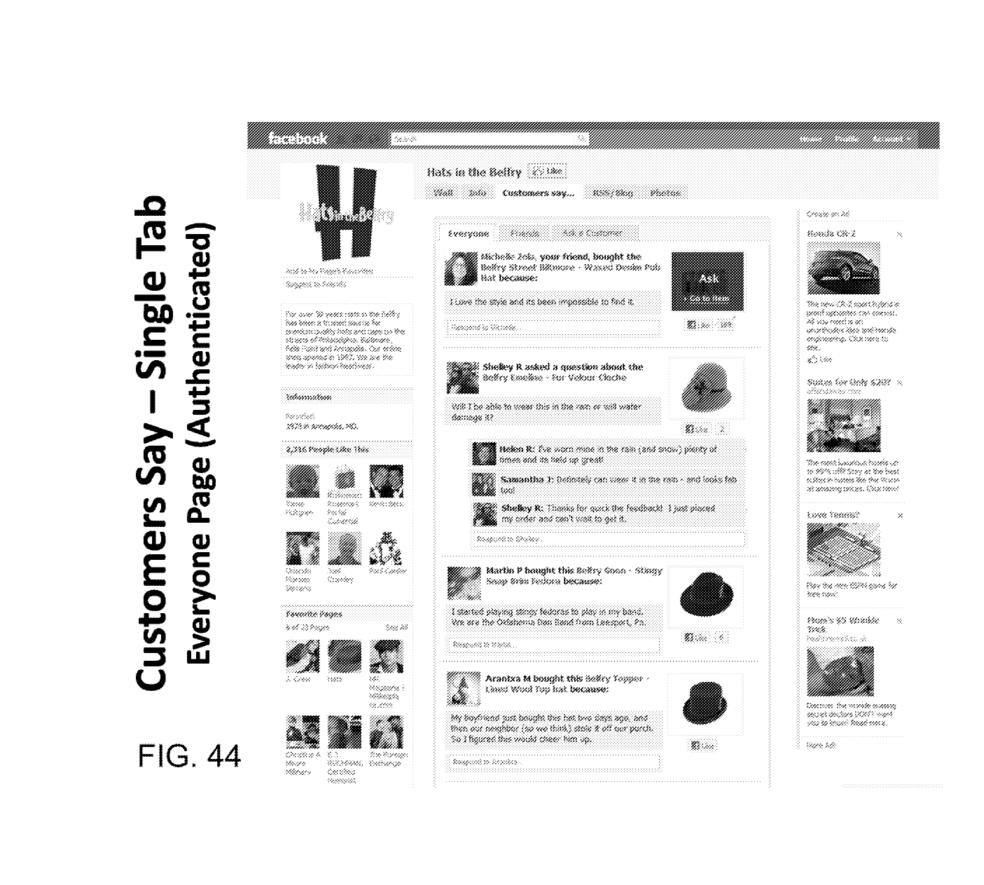

Under the everyone one sub tab, each posting has an indication of the identity of a user 1078 and an action taken by that user 1080, a product identifier 1082, and a comment, question, or answer 1084, and a text entry box 1086. Each posting also includes a picture of the product 1088, a button to indicate that you like the entry, and the number of people 1092 who said that they like the entry. In some cases, there is a chain of question and answers 1094. When a user of the Facebook page rolls her mouse pointer over a product picture, the box 1096 appears, giving the user the opportunity to indicate that she wishes to ask a question or to go to see more information about the item. FIGS. 43 and 44 show essentially the same information, but FIG. 43 represents the situation when an unauthenticated Facebook user is viewing the page, while FIG. 44 represents the situation when an authenticated user is viewing the page.

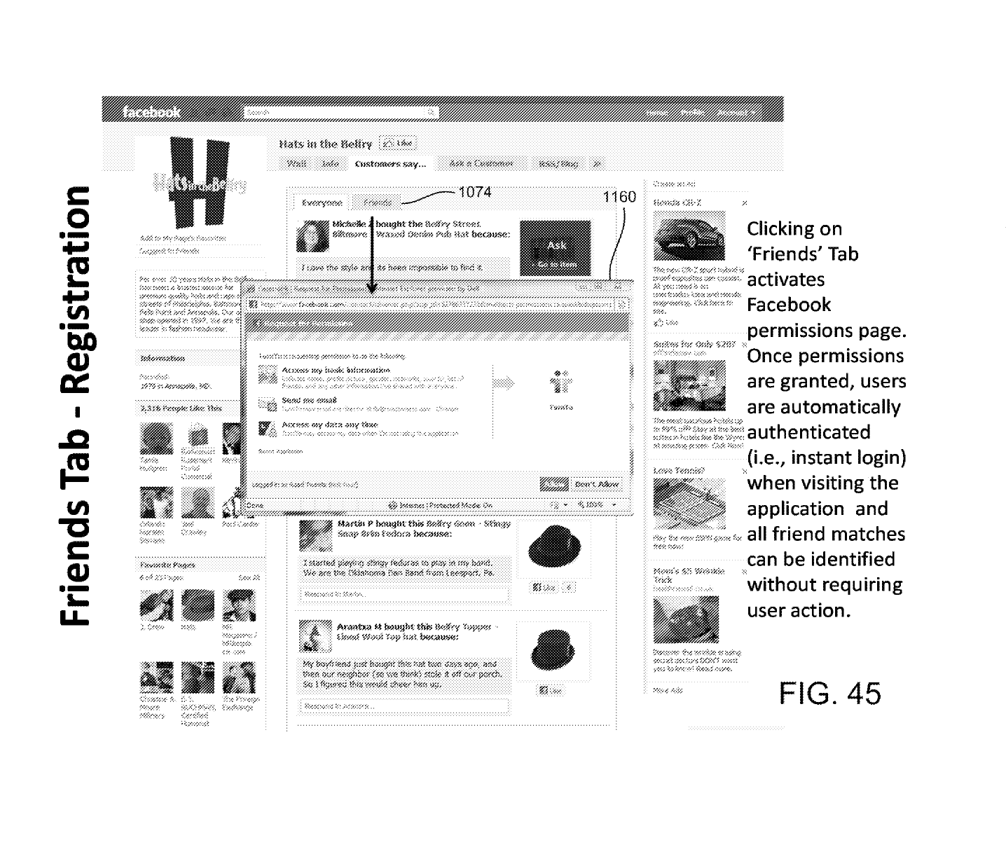

As shown in FIG. 45, when a user clicks on the friends sub tab 1074, the Facebook permissions panel 1110 opens. The user is then requested to give permission for the host operator (in this case, turn to) to access the user's basic information on Facebook, send the user an e-mail, and access the data at any time. The user can allow or not allow the permission, in the usual way. Once the permissions have been granted, the user is automatically authenticated (that is, automatic login occurs) when the user visits any page on which the system is running In addition, social networking matches between the user and the user's friends can be made by the host operator without requiring action by the user.

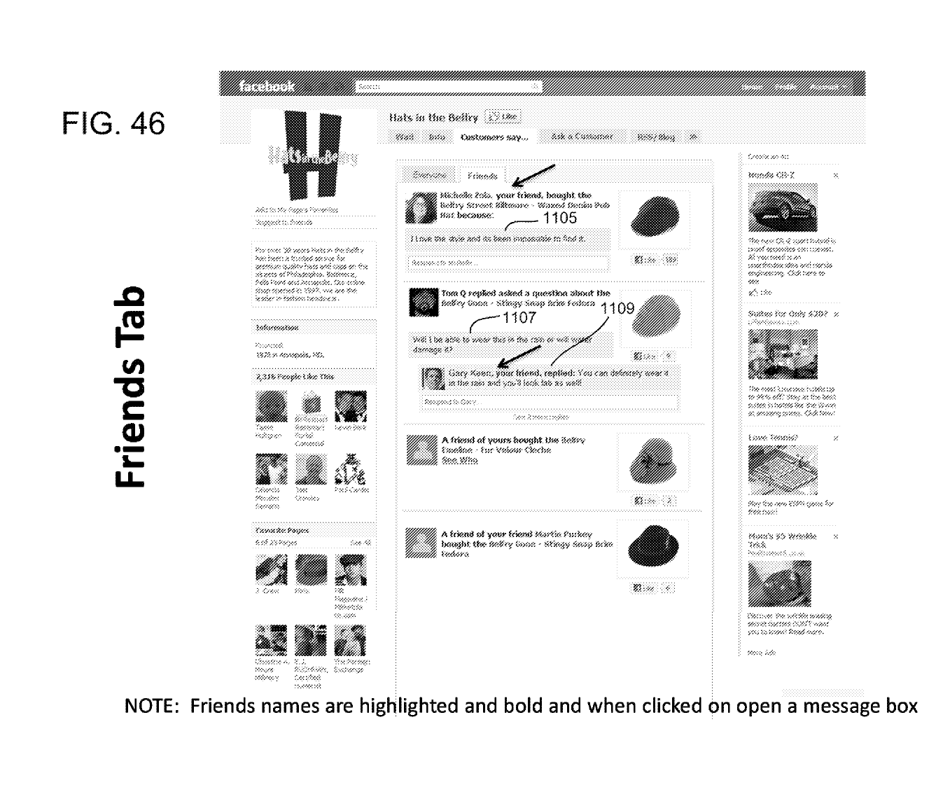

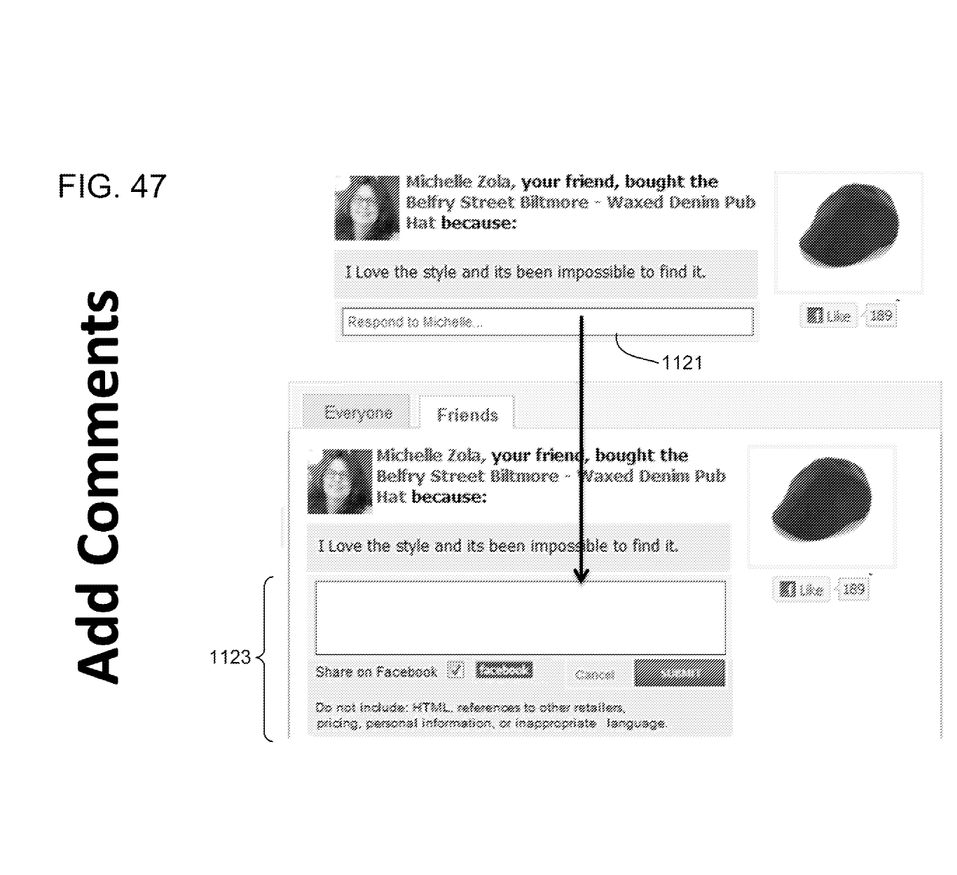

As shown in FIG. 46, once the authentication has occurred, the user will see, in the friends sub tab, answers to the questions provided by the user's friends. As shown, the name of the friend is indicated. In addition, the user can see other comments 1105, such as the reason why the named person chose to buy the product. As shown in FIG. 47, the user is also enabled to respond to the friend' s comments or the friend' s answer in a text box 1121 which opens up to provide a larger text entry box, other options, and information related to the addition of a comment, all as indicated in sub panel 1123. In addition, the user may be able to see purchases made by friends (or others in the user's extended social network), with specific identification of the friend where the friend has given permission, or non-specific identification (ie “a friend of yours bought . . . ”) where permission from the friend to show his/her name has not been obtained.

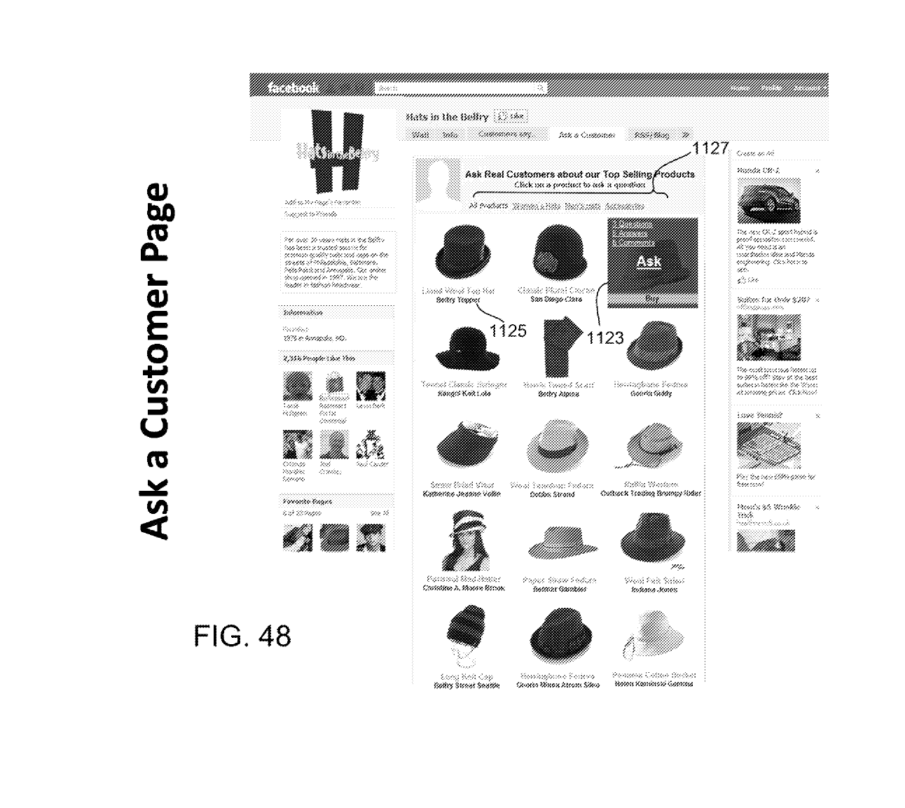

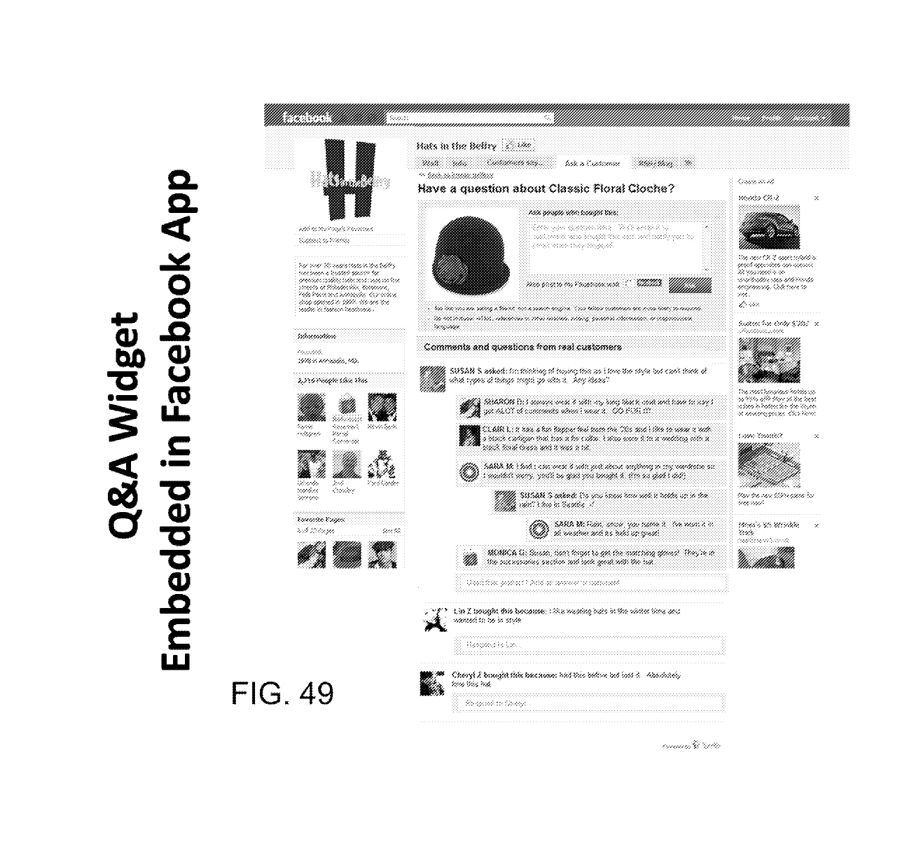

As shown in FIG. 48, in some implementations, an additional tab, called “Ask a Customer”, contains a catalog of product items 1125, which contains top-selling products falling into various categories 1127. When a user rolls a mouse pointer over any of the items, the box 1123 appears, enabling the user to ask a question, buy the product, or see that (in this case) three questions have been posed, five answers given, and six comment provided. If the user clicks on the “ask” link in box 1123, he is presented with the Facebook page shown in FIG. 49. The layout, information, features, and text entry boxes on this page are similar to the one described previously. However, instead of being displayed on the retailer's own site, they are embedded here within the Facebook fan page. FIG. 50 shows an example posting 1140 that repeats the question just entered by the user and provides the status of the question in the system. When answers are provided by other people, the answers are e-mailed to the user in a manner similar to the one described earlier.

Sometimes, we refer to the upper part 859 of panel 846 of FIG. 30 as an “ask widget”. This ask widget, which appears in several of the figures described above, could, of course, be implemented in a wide variety of other ways. The elements included in the widget, its layout, location, position, shape, and other aspects of the design and functionality could be different from the one shown in the examples. In the discussion above, we have also discussed different ways to reach the ask widget from retail sites, other sites, and from e-mails directed to purchasers or prospective purchasers or other people engaged in activities related to the system. Again, a very wide variety of techniques could be used to invoke the ask widget and the invocation can occur from a wide variety of sources, including online sites.

The Q&A system uses a set of logical rules or algorithms to determine how many potential responders to approach for answers to each question posed, and which potential responders to approach. A wide variety of rules, principles, and algorithms can be used for this purpose.

One principle is the need to get at least one (and perhaps a few) answers to a question within a reasonable period of time. The reasonable period of time could be on the order of 10 or 15 minutes, as short as 30 seconds, and as long as several hours or even several days. The acceptable period will depend on the context in which the question was asked, the place where it was asked, the user who asked it, the reasonable expectations of the person who asked it, a history of questions and answers, and a wide variety of other possible factors.

The Q&A system has access to enough information to determine how many other people who bought the same product (or product of a similar class) are in the pool of possible responders. The Q&A system can also use algorithms and logical rules to infer how many responses can reasonably be expected within a predetermined amount of time based on the number of potential responders in the pool, and other factors.

If the Q&A system determines that the pool of potential responders is too small to permit an accurate prediction that an acceptable number of answers would be provided within a predetermined amount of time, the Q&A system can withhold from the user the opportunity to pose a question. For example, in such a case, the Q&A system would prevent the “ask” link from appearing when a user moves the mouse pointer over a product on a site. On the other hand, if the number of anticipated responses would be reasonable within the predetermined amount of time, the Q&A system would allow the opportunity to be presented to the user as explained above.

In determining which people to include within the pool of potential responders, the Q&A system could take account of when people made relevant purchases. For example, people who made purchases of the product more than a year prior to the posing of the question could be excluded from the pool. The theory would be that the recollections of those people about the product may be so old as to undercut the credibility, completeness, and accuracy of their answers.

By the same token, the Q&A system could that exclude from the pool people who have made purchases more recently than, say, two weeks earlier than the question. Here, the reasoning would be that very recent purchasers have not had enough experience with the product to provide accurate, complete, incredible answers.

In addition, once the pool of potential responders has been created, the Q&A system would make choices of which people to approach. For example, if the pool contains 4000 people, but only 400 people need to be approached in order to get the desired number of responses, the Q&A system would make choices about which of the people to approach.

Again, there are a wide variety of rules that could be used in making these choices.

As one example, the Q&A system could distribute the selections of responders in accordance with how long the different potential responders have owned the product. The reasoning here is that peoples views of a product change over time. By mixing the selection of responders over time, a richer and more useful set of answers might be provided.

The selection of which responders to approach could also be controlled based on relationships between the asker and potential responders. For example, the Q&A system could use social networking information to select responders who are known to be social networking contacts of the asker. The reasoning here is that people who are “friends” of the asker may be able to provide more useful information, and the asker may be more likely to view those people as credible sources of information. Responders can also be selected based on a person's membership in the user's extended social network, such as second- or third-degree friends, or because a person shares characteristics with the user, such as living in the same area, sharing group memberships, working at the same businesses or in the same industries or roles, attending the same schools or receiving similar degrees, speaking the same languages, having similar families or similar roles in their families (ie mothers of twins), being a similar age or ethnicity, etc... Conversely, the Q&A system could deliberately also choose as responders people who are known not to be social networking contacts of the asker, on the theory that their responses might be more objective and more credible to the asker. Or a combination of the two could be used.

The Q&A system could be configured so that it would ask the user to indicate choices about which kinds of responders should be approached. For example, the user could be asked to indicate whether she wanted the responders to be only social networking contacts of hers, only people who are not networking contacts of hers, or some mix of the two. Choices could also be made with respect to how long the potential responders have owned the product, their geographic location, whether they purchased the product at the same site as the asker who is posing the question, and a wide variety of other information. In cases in which the pool of potential responders with respect to a particular product and brand (for example, specific SKU number) is too small, the system could ask the user whether she is interested in seeing responses that relate to other similar products.

The Q&A system can also base selection of respondents on the purpose for which the buyer made the purchase, which information may be requested of the buyer at the time of purchase. For example, buyers may be asked if the purchase is a gift, and buyers who made the purchase as a gift may be excluded or included in the pool of respondents based on that factor.

One aspect of the Q&A system that makes it especially effective is that the responders can be pre-validated as credible responders who have some experience with the product and with whom communication can be arranged quickly and easily. For example, the Q&A system has a body of transaction records from sites that are useful to know which people have purchased which products at which times, has e-mail addresses of those people, and is aware of whether or not they have opted out of the e-mail feature of those sites. Therefore, the Q&A system can determine immediately who is in the pool of possible responders, how to communicate with them, and is confident that the communication is permitted. For this purpose, the Q&A system receives data feeds from participating sites. The feeds can include transaction information, email opt-in/out information, user profile information for the site, and a wide variety of other data.

In a broad sense, then, the Q&A system (which we also sometimes called the Q&A engine) (a) solicits and accumulates questions from online users at a wide variety of places and with respect to particular products (or other items of interest which may not necessarily be commercial products for sale), (b) identifies a pool of possible responders who purchased the same product (or, in a broader sense, have some credible knowledge about the item or the subject of the question) and who may be sent messages (either because of explicit opt-in or through their relationships with online properties participating in the Q&A service), (c) uses rules, logic, and algorithms to identify appropriate responders, (d) automatically and promptly approaches those responders for answers to the question, (d) accumulates answers from the responders electronically, and (e) feeds the answers back to the askers.

The solicitation of questions and the solicitation of answers can be done somewhat independently. The sourcing of questions can occur on commercial sites, noncommercial sites, comparison sites, portals, search sites, social networking sites, blogs, review sites, discussion forums, publications, through e-mail, and in a wide variety of other ways. The Q&A service may provide an API that enables other applications to submit questions and will return answers. The Q&A service may be made available through apps on mobile devices (perhaps in conjunction with barcode scanners that enable easy identification of items about which questions may be asked when the user is in a store environment). The solicitation and feeding back of answers can also occur in all of these different ways.

The Q&A system can solicit the questions and answers and feed the answers back to the askers directly in the context of possible purchase decisions of either askers or responders. In other words, at the very moment when an asker is viewing her own question and credible, useful answers provided by responders, she is also presented with a “buy” button that enables an immediate purchase to be made. The buy button is not merely a banner advertisement appearing on the same page. It is a buy button associated with the precise product that the asker has inquired about and is positioned in direct association with the text of the question and answer. By providing a user who was considering but has not yet consummated a purchase with reminders of their intent coupled with links to locations where the purchase can be made, the Q&A can enhance the volume of sales of products, for example.

The prospect of associating an immediate and direct buying opportunity with credible answers to questions about a product is appealing to merchants, for example, and provides a strong incentive for the merchants to allow a feed of transaction information to be delivered to the Q&A system as a way to enhance sales.

Said another way, the Q&A system sources, for a merchant, intent to buy on the part of shoppers in a compelling way. That is, there is high likelihood that someone who asks a product-related question has some intent to buy the product. This intent to buy can be inferred much more strongly than would be the case for typical banner advertisements placed on websites.

Search engines increasingly give weight to the presence of user-generated content on brand and store sites, such as customer reviews, in determining page ranking One advantage of the Q&A system is that the user-generated content it produces can improve the search engine ranking of pages containing this content.

In the case of the Facebook example, the new tabs, when placed on a merchant's fan page, can provide a much higher level of vibrancy to the merchant' s page. When merchants establish fan pages on social networking sites, they typically are hoping to create a buzz among their customers and potential customers. In reality, creating this buzz is difficult to do and merchants are often not successful. The credible questions and answers contained on the new tabs discussed above and credibility to the merchants site, without requiring any additional effort by the merchant.

The Q&A system may be able to stimulate a higher percentage of question recipients who respond than may be the case with other approaches. Among the reasons for this may be one or more of the following. The responders are prequalified in the sense that the Q&A system knows that they have bought the product or have some other connection to it. The logic, rules, and algorithms are arranged so that interest and willingness of a potential responder to respond is increased. Each step in each aspect of the process followed by the Q&A system is designed to be quick and easy. The user can easily ask a question about a product at a moment and in a place where it is natural to do that. The user does not need to navigate to another site or take any other action other than to indicate an interest in the product, ask the question, and click submit. The Q&A system then handles the process of approaching the responders. The approaches are made in an appealing way that ties the request to a particular site in a particular product. And the responder can leave that easily enter an answer. The answers are accumulated automatically fed back to the asker without either the asker or the responder needing to take any further action.

A wide variety of additional features may be provided in the Q&A system. For example, one issue is how often a potential responder will receive a question to be answered. The number can be controlled in a simple way, for example, by a rule that a responder will not be presented with a question more than once a month. Another rule would be to prioritize responders for a given product in a round robin queue, so that, after a responder has received a question, he is put at the end of the line for subsequent questions.

More sophisticated rules are possible, including both declared and inferred rules. Declared rules can be of the form “How often would you like to receive questions from fellow shoppers?” Inferred rules could be of the form:if someone answers a question, he is identifying himself as of the question-answering type, that is, a person to whom more questions might be sent without irritating him. In some implementations, if someone receives a question and doesn't answer, the Q&A system can assume this might be because the question was irrelevant or the approached responder didn't receive it. The person could then be put back in the pool after a baseline amount of time has passed. If someone repeatedly doesn't answer questions, the Q&A system can infer he doesn't want to answer questions and so, adaptively, send him fewer and fewer.

The Q&A system can be implemented as Javascript and displayed to the user as an overlay, as explained in shown in the examples discussed above. A wide variety of other implementations are possible. For example, implementations could run within an iFrame and appear to the user as embedded within a page. Other implementations are possible, such as ones where the content is delivered from TurnTo (an example of a host of a Q&A system and/or of a broader shared social networking system) to a hidden page on the store site where it can be indexed by search engines to provide search engine optimization benefits, and from there to the pages where it is exposed to the shopper.

In typical known systems, if a shopper uses a third-party service to authenticate himself (e.g., logs in using Facebook, Twitter, Google, Yahoo, for example), the shopper is technically authenticating himself to the TurnTo service, not to the online store. The Q&A host system could also offer account integration facilities so that the authentication creates an account for the shopper with the merchant instead of, or in addition, to TurnTo. (This is an additional benefit of the Q&A system to the merchant.) Likewise, a shopper who is already logged-in to a store site would be automatically treated as logged-in to the TurnTo service.

The Q&A system could offer rewards to people for asking and answering questions. These may be in the form of community/status items, like badges, levels, points, titles, or items of explicit value like discounts, free shipping, or coupons at partner merchants. Various mechanisms can be used for the determining rewards, including the volume of a participant's contributions in the form of comments or answers, or ratings of contribution quality by other users (e.g. thumbs up/down, this-was-helpful, etc.). In general, these mechanisms have come to be called game mechanics and/or reputation systems.

The Q&A system could include an item categorization or tagging scheme. Such a scheme could enable a question to be routed to buyers of related items, could enable a merchant to easily exclude a category of products for the system (e.g., health-related books in a bookstore), and could enable the Q&A system to route questions to buyers of similar items sold by different merchants (who may use incompatible SKUs or item names).

Since a user who asks a question is likely expessing purchase intent, merchants will be eager to have questions routed to respondents who purchased at their stores if the answers from those respondents contain links back to that merchant's store. When the item to which the question applies has been purchased from more than one store participating in the Q&A system, the Q&A system may contain rules regarding how questions are allocated among the stores contributing to the respondent pool. One rule for doing the allocation would be pro rata according to the volumes of transactions fed from the respective retail sites to be Q&A system. That is, if one site fed 40,000 transactions to the Q&A system in July and another site fed 20,000 transactions, respondents from the first site would receive twice as many questions as the second site.

This dynamic will create a Q&A marketplace with strong network economies. Organizations that have lists of people coupled with indicators of some knowledge those people likely have (for example, a list of customers and the products they bought) along with permission to message those people can provide those lists and the associated data about those people in order to increase the likelihood that an asker's question is answered by a respondent they contributed to the pool. As more and more respondents are contributed to the pool, the ability of the system to deliver many and fast responses to questions improves, which will attract more askers. The more askers, the greater the value to organizations that contribute answers, in a reinforcing cycle.

An alternative rule for question allocation would be to reward stores for continuity in participation by allocating more questions to stores which have participated in the Q&A system longer. In some implementations, the Q&A system could enable a merchant to pay to have more questions allocated to its respondents.

The provider of the Q&A system could be paid by the merchant for each asker that goes on to make a purchase (a CPA model), and in a variety of other ways. The expression of purchase intent implied by a product related question could also be monetized by showing targeted ads, or by selling targeting data to exchanges, and in a variety of other ways.

Although much of what has been said above relates to the posing of questions and accumulating answers to the questions, additional information about products can be provided by having people who purchase a product provide comments such as the reasons for their purchase. These comments need not be given in response to specific questions, but could be provided, for example, at the time of purchase.

A wide variety of other implementations are also within the scope of the claims.

1. A computer-implemented method comprising
exposing, to a user who is engaged in a commercial activity on a commercial online site, computer-stored information that (a) is associated with another user of the online site, (b) would otherwise be private to the other user, (c) relates to the commercial activity of the user, and (d) is controlled by the site.

2. The method of claim 1 in which the user who is engaged in the commercial activity and the other user are known to have a connection with one another.

3. The method of claim 1 in which the commercial activity includes shopping for a product or service.

4. The method of claim 1 in which the computer-stored information includes information about activities of the other user on the online site.

5. The method of claim 1 in which the computer-stored information includes information about a product or service bought by the other user on the site.

6. The method of claim 1 in which the computer-stored information comprises information about purchases at the site by users of the site.

7. The method of claim 1 in which the exposing of the user to the information includes facilitating an interaction between the user who is engaged in the commercial activity and the other user.

8. The method of claim 7 in which the facilitating of an interaction includes initially displaying some of the information without any information that is private to the other user.

9. The method of claim 7 in which the facilitating comprises serving as a conduit for a question of the user directed to the other user, and an answer of the other user.

10. The method of claim 7 in which the facilitating is assisted by a third party social networking system.

11. The method of claim 1 in which the information includes a recommendation of the other user.

12. The method of claim 1 in which the user and the other user are connected through a social networking site.

13. The method of claim 1 in which the connection of the user and the other user is determined by information provided by the user, the other user, or both.

14. The method of claim 1 in which the exposing includes identifying a connection between the user and the other user based on identifiers associated with at least one of the users, and selecting information to be exposed, based on the identified connection.

15. The method of claim 1 in which the other user has given permission to the exposing of the information to the user who is engaged in the commercial activity.

16. The method of claim 1 in which the information that is exposed to the user is a selected subset of available information that could be exposed to the user.

17. The method of claim 1 in which the information that is exposed is organized by a product item or a product category.

18. A computer-implemented method comprising receiving an online inquiry from a user who is contemplating a transaction on an online site,
identifying one or more other users of the online site to whom to direct the inquiry, based on stored information about other transactions that have occurred on the online site.

19. The method of claim 18 also including: obtaining from the stored transaction information, data that enables the online inquiry to be sent to the other users.

20. The method of claim 18 in which the stored information about other transactions is controlled by the online site.

21. The method of claim 18 in which the online inquiry relates to a product that the user is contemplating buying, and at least some of the other transactions include transactions that relate to the product that the user is contemplating buying.

22. The method of claim 18 in which the user and the one or more other users are friends in a social networking system.

23. A method comprising
sending a question about a product to a potential responder who can be inferred to have knowledge about the product, based on data that is controlled by an online site and is about an action of the potential responder at the online site.

24. The method of claim 23 in which the action of the potential responder comprises purchasing the product.

25. The method of claim 23 in which the online site comprises a retail online site.

26. The method of claim 23 in which the question is sent by email.

27. The method of claim 23 in which the question is displayed to the responder at an online site.

28. The method of claim 23 in which the potential responder is selected from a pool of potential responders.

29. The method of claim 28 in which the selection is based on at least one factor that indicates that the responder will provide a useful response to the question.

30. A method comprising
receiving, from an online site, data about an action of a potential responder at the online site from which it can be inferred that the potential responder has knowledge about a product, and returning, for use by the online site, an answer of the potential responder to a question about the product.

31. The method of claim 30 in which the action of the potential responder comprises purchasing the product.

32. The method of claim 30 in which the online site comprises a retail online site.

33. The method of claim 30 in which the data received from the online site identifies that the potential responder bought the product on the site.

34. The method of claim 30 in which the data received from the online site is part of a body of data about transactions that occurred at the online site.

35. The method of claim 30 in which the answer is used by the online site to increase traffic on the site.

36. The method of claim 30 in which the answer is used by the online site to increase purchases on the site.

37. The method of claim 30 in which the answer is provided by the online site to a shopper who posed the question together with an invitation to purchase the product.

38. The method of claim 30 in which the answer is posted with the question on a page on a social networking site that is associated with the online site from which the data was received.

39. The method of claim 30 in which the answer is provided in an email.

40. A method comprising
sending a question about a product from a shopper at an online site to one or more potential responders who can be inferred to have knowledge about the product, based on data that is controlled by one or more other online sites and is about actions of the potential responders at the other online sites.

41. The method of claim 40 in which the actions of the potential responders comprise purchasing the product.

42. The method of claim 40 in which online sites comprise retail online sites.

43. The method of claim 40 in which the question is sent by email.

44. The method of claim 40 in which the question is sent by displaying it to the potential responders at online sites.

45. The method of claim 44 in which the potential responders are selected from a pool of potential responders.

46. The method of claim 45 in which the selection is based on at least one factor that indicates that the responders will provide useful responses to the question.

47. The method of claim 40 in which the data received from the online site identifies that the potential responder bought the product on the site.

48. The method of claim 40 in which the data received from the online sites is part of a body of data about purchase transactions that occurred at the online sites.

49. The method of claim 40 in which the question is used by the online site to increase traffic on the site.

50. The method of claim 40 in which the question is used by the online site to increase purchases on the site.

51. A method comprising
receiving from one or more online sites, data about actions of one or more potential responders at the online sites from which it can be inferred that the potential responders have knowledge about one or more products, and returning to other online sites, answers of the potential responders to questions about the products.

52. The method of claim 50 in which the actions of the potential responders comprise purchasing the product.

53. The method of claim 50 in which online sites comprise retail online sites.

54. The method of claim 50 in which the questions are sent by email.

55. The method of claim 50 in which the questions are sent by displaying them to the potential responders at online sites.

56. The method of claim 55 in which the potential responders are selected from a pool of potential responders.

57. The method of claim 56 in which the selection is based on at least one factor that indicates that the responders will provide useful responses to the question.

58. The method of claim 51 in which the data received from the online site identifies that the potential responders bought the product on the sites.

59. The method of claim 51 in which the data received from the online sites is part of a body of data about purchase transactions that occurred at the online sites.

60. The method of claim 51 in which the questions are used by the online sites to increase traffic on the sites.

61. The method of claim 51 in which the questions are used by the online sites to increase purchases on the sites.

62. The method of claim 51 in which the answers are provided by the online sites to shoppers who posed the question together with invitations to purchase the product.

63. The method of claim 51 in which the answers are posted with the questions on pages on social networking sites that are associated with the online sites from which the data was received.

64. The method of claim 51 in which the answers are provided in emails.

65. A method comprising
incentivizing an online site to deliver as much data as possible about actions of people on the site from which knowledge of the people about respective products can be inferred, by using the data to enhance the likelihood that shoppers who have asked questions about the products will buy the products.

66. The method of claim 65 in which the questions that have been asked by the shoppers about the products have been asked at a location other than the online site that delivers the data.

67. The method of claim 65 in which the data comprises transactions that include purchases of products on the online site.

68. The method of claim 65 in which the data is used to identify potential responders to the questions.

69. The method of claim 65 in which the data is used to determine potential responders who have agreed to permit the communications to be made to them on behalf of the online site.

70. The method of claim 65 in which the likelihood that shoppers will buy is enhanced by returning for use by the online site, answers to the questions provided by responders identified using the data.

71. A method comprising
sending questions about products to potential responders who have engaged in activities on an online site from which it can be inferred that they have knowledge about the products, the potential responders' consent to having the questions sent to them being inferred from permissions that the potential responders have granted to the online site to send messages to them.

72. The method of claim 71 in which the permissions have been provided as part of registration by the responders with the online site prior to a time when the questions are to be sent.

73. The method of claim 71 in which the permissions granted to the online site are general permissions to communicate with the responders.

74. The method of claim 71 in which a responder can opt out of receiving future questions at the time when a question has been sent to him.

75. A method comprising
providing a service to accept, from any arbitrary sources, identifications of items of commerce and questions about the items, and to respond to the questions with (a) answers from responders who can be inferred to have knowledge about the items based on activities of the responders at other sites and (b) pointers to the sites where the activities of the responders occurred.

76. The method of claim 75 in which the service comprises an application programming interface that may be used by any arbitrary entity to establish a feature in which the entity can send the questions and receive the answers automatically.

77. The method of claim 75 in which the service is provided by an independent third party syndicator of the questions and answers.

78. A method comprising
displaying to a shopper an answer to a question posed by the shopper about a product, the answer being provided by a responder who can be inferred to have knowledge about the product, and displaying with the answer, a control that enables the shopper to proceed with a purchase of the product.

79. The method of claim 78 in which the answer is displayed on an online site used by the shopper.

80. The method of claim 78 in which the answer is provided in an email to the shopper.

81. The method of claim 78 in which the answer is displayed on a page of a social networking site.

82. The method of claim 78 in which the control comprises a “buy” button that intiates for the shopper a process for buying the product.

83. The method of claim 78 in which the control comprises an image of the product.

84. The method of claim 78 in which the question is posed by the shopper on the online site or on a page of a social networking site.

85. A method comprising
including on a business's page on a social networking site, questions posed by shoppers about products on the business's website, and answers to those questions provided by responders who can be inferred to have knowledge about the respective products.

86. The method of claim 85 in which the questions and answers are included as posts.

87. The method of claim 85 in which the page of the social networking site includes a place for displaying information about products available at the business's website and a place for shoppers to pose questions about the products.

88. The method of claim 85 also including a control to be used by shoppers to initiate a purchase of a product associated with the questions and answers.

89. A method comprising
including on a business's page on a social networking site, a facility that enables a user to post a question about a product offered by the business and that posts answers from responders who can be inferred to have knowledge about the respective products.
